(19) United States
(12) Patent Application Publication
(10) Pub. No.: US 2026/0371334 A1
(43) Pub. Date: Nov. 19, 2026

(54) THE EFFICIENCY OF DYNAMIC SUBBAND OPERATION THROUGH DOWNLINK DATA AVAILABILITY STATUS INDICATION

(71) Applicant: NEWRACOM, Inc., Irvine, CA (US)

(72) Inventors: Si-Chan NOH, Seoul (KR); Joonsoo LEE, Irvine, CA (US)

(73) Assignee: NEWRACOM, Inc., Irvine, CA (US)

(21) Appl. No.: 19/670,971

(22) Filed: May 7, 2026

Related U.S. Application Data
(60) Provisional application No. 63/807,474, filed on May 16, 2025.

(51) Int. Cl. H04W 72/0457; H04W 74/0833

(52) U.S. Cl. CPC H04W 72/0457; H04W 74/0833

(57) ABSTRACT

Disclosed herein is a method performed by an access point (AP) to initiate dynamic subband operation (DSO). The method includes transmitting an initial control frame to initiate DSO, wherein the initial control frame includes a downlink data availability field for a DSO-capable station (STA) that indicates that the AP does not have any downlink data to transmit to the DSO-capable STA and determining that the DSO-capable STA does not have any uplink data to transmit to the AP and will not perform DSO subband switching in response to determining that the DSO-capable STA did not respond to the initial control frame.

### CROSS-REFERENCE TO RELATED APPLICATION

This application claims the benefit of U.S. Provisional Application No. 63/807,474, filed May 16, 2025, titled “Dynamic Spatial Operation Enhancement for Efficient DL/UL Data Indication and Scheduling in Wireless LAN Systems”, which is hereby incorporated by reference.

### TECHNICAL FIELD

The present disclosure generally relates to wireless communications, and more specifically, relates to improving the efficiency of dynamic subband operation (DSO) through downlink data availability status indication.

### BACKGROUND

Institute of Electrical and Electronics Engineers (IEEE) 802.11 is a set of standards for implementing wireless local area network communication in various frequencies, including but not limited to the 2.4 gigahertz (GHz), 5 GHz, 6 GHz, and 60 GHz bands. These standards define the protocols that enable Wi-Fi devices to communicate with each other. The IEEE 802.11 family of standards has evolved over time to accommodate higher data rates, improved security, and better performance in different environments. Some of the most widely used standards include 802.11a, 802.11b, 802.11g, 802.11n, 802.11ac, and 802.11ax (also known as “Wi-Fi 6”). These standards specify the modulation techniques, channel bandwidths, and other technical aspects that facilitate interoperability between devices from various manufacturers. IEEE 802.11 has played an important role in the widespread adoption of wireless networking in homes, offices, and public spaces, enabling users to connect their devices to the internet and each other without the need for wired connections.

Dynamic subband operation (DSO) is a feature that allows a non-access point station (non-AP STA) to be dynamically allocated bandwidth outside of its current operating bandwidth on a per-transmission opportunity (per-TXOP) basis, as long as it is within the associated AP's operating bandwidth. DSO addresses inefficiencies caused by the difference in maximum supported bandwidth (BW) between access points (APs) and non-AP STAs. For example, in the IEEE 802.11be (also referred to as Extremely High Throughput or EHT) wireless networking standard (which is the wireless networking standard prior to IEEE 802.11bn (also referred to as Ultra High Reliability or UHR), currently under development), a single link could support up to a 320 MHz bandwidth, but it is expected that UHR APs will be able to support even wider bandwidths. It is expected that UHR non-AP STAs will support a maximum bandwidth of 160 MHz or less. This mismatch between the bandwidth capabilities of APs and non-AP STAs can lead to the underutilization of the AP's available bandwidth resources. For example, even though an AP supports a maximum bandwidth of 320 MHz, it might only use 160 MHz of its bandwidth to serve a non-AP STA that supports a maximum bandwidth of 160 MHz, thus leaving the remaining 160 MHz bandwidth unused. DSO allows the AP to utilize the remaining 160 MHz bandwidth to transmit/receive to/from other non-AP STA(s).

An AP may initiate DSO with non-AP STAs by transmitting a buffer status report poll (BSRP) frame to the non-AP STAs. The non-AP STAs that receive the BSRP frame may perform DSO subband switching (i.e., switch from operating in a non-DSO (primary) subband to operating in a DSO subband) and transmit a buffer status report (BSR) frame to the AP as a response to the BSRP frame. The AP may then perform DSO with the non-AP STAs during a DSO operation period.

Although DSO can improve bandwidth utilization and data processing efficiency, it may have unintended drawbacks such as increased battery consumption. In particular, if DSO subband switching is performed frequently or if a DSO-capable non-AP STA does not participate in actual data transmission and reception after performing DSO subband switching, the disadvantages may outweigh the benefits. Also, with existing DSO mechanisms, the AP may not have knowledge regarding which non-AP STAs have uplink data to transmit to the AP and thus may not be able to properly schedule non-AP STAs for uplink transmission during the DSO operation period.

### BRIEF DESCRIPTION OF THE DRAWINGS

The disclosure will be more fully understood from the detailed description provided below and the accompanying drawings that depict various embodiments of the disclosure. However, these drawings should not be interpreted as limiting the disclosure to the specific embodiments shown; they are provided for explanation and understanding only.

FIG. 1 illustrates an example of a wireless local area network (WLAN) with a basic service set (BSS) that includes multiple wireless devices, in accordance with some embodiments of the present disclosure.

FIG. 2 is a schematic diagram of a wireless device, in accordance with some embodiments of the present disclosure.

FIG. 3A illustrates components of a wireless device configured to transmit data, in accordance with some embodiments of the present disclosure.

FIG. 3B illustrates components of a wireless device configured to receive data, in accordance with some embodiments of the present disclosure.

FIG. 4 illustrates interframe space (IFS) relationships, in accordance with some embodiments of the present disclosure.

FIG. 5 illustrates a Carrier Sense Multiple Access with Collision Avoidance (CSMA/CA)-based frame transmission procedure, in accordance with some embodiments of the present disclosure.

FIG. 6 illustrates maximum physical layer (PHY) rates for Institute of Electrical and Electronics Engineers (IEEE) 802.11 standards, in accordance with some embodiments of the present disclosure.

FIG. 7 provides a detailed description of fields in Extremely High Throughput (EHT) Physical Protocol Data Unit (PPDU) frames, including their purposes and characteristics, in accordance with some embodiments of the present disclosure.

FIG. 8 illustrates an example of multi-user (MU) transmission in Orthogonal Frequency-Division Multiple Access (OFDMA), in accordance with some embodiments of the present disclosure.

FIG. 9 illustrates an example of an access point sending a trigger frame to multiple associated stations and receiving Uplink Orthogonal Frequency-Division Multiple Access Trigger-Based Physical Protocol Data Units (UL OFDMA TB PPDUs) in response, in accordance with some embodiments of the present disclosure.

FIG. 10 is a diagram showing the concept of dynamic subband operation (DSO), according to some embodiments.

FIG. 11 is a diagram showing a frame exchange for performing DSO, according to some embodiments.

FIG. 12 is a diagram showing a common information field format that includes an initial control frame (ICF) function type field that can be used to indicate that an initial control frame is being transmitted for the purpose of initiating DSO, according to some embodiments.

FIG. 13 is a diagram showing another common information field format that includes an ICF function type field that can be used to indicate that an initial control frame is being transmitted for the purpose of initiating DSO, according to some embodiments.

FIG. 14 is a diagram showing a user information field format, according to some embodiments.

FIG. 15 is a diagram showing how a spatial stream allocation field can be repurposed/modified to include a downlink data availability field, according to some embodiments.

FIG. 16 is a diagram showing how a spatial stream allocation field can be modified/repurposed to include a downlink data availability field, according to some embodiments.

FIG. 17 is a flow diagram of a method for initiating DSO, according to some embodiments.

FIG. 18 is a flow diagram of a method for determining whether to perform DSO subband switching, according to some embodiments.

### DETAILED DESCRIPTION

The present disclosure generally relates to wireless communications, and more specifically, relates to improving the efficiency of dynamic subband operation (DSO) through downlink data availability status indication.

As mentioned earlier herein, although DSO can improve bandwidth utilization and data processing efficiency, it may have unintended drawbacks such as increased battery consumption. In particular, if DSO subband switching is performed frequently or if a DSO-capable non-access point station (non-AP STA) does not participate in actual data transmission and reception after performing DSO subband switching, the disadvantages may outweigh the benefits. Also, with existing DSO mechanisms, the access point (AP) may not have knowledge regarding which non-AP STAs have uplink data to transmit to the AP and thus may not be able to properly schedule non-AP STAs for uplink transmission during the DSO operation period.

The present disclosure describes embodiments that can implement DSO more efficiently. An embodiment may introduce/add a new downlink data availability field to an initial control frame (ICF) transmitted by the access point (AP) to DSO-capable stations (STAs) to indicate whether the AP has downlink data to transmit to the DSO-capable STAs. The user information field (also referred to as a user info field) of the initial control frame may be extended/modified to indicate the downlink data availability status on a per-user/STA basis. Certain fields within the user information field may be repurposed/reused to indicate the downlink data availability status for a particular STA. For example, the spatial stream (SS) allocation field within the user information field may be repurposed/reused. It is recognized by the present disclosure that the spatial stream allocation field can be repurposed/reused because the number of spatial streams indicated in the user information field of an initial control frame (e.g., when a buffer status report poll (BSRP) frame is used as the initial control frame) is fixed to one (1) so the subfield/bits within the spatial stream allocation field that are typically used for indicating the number of spatial streams can be used for other purposes such as indicating the downlink data availability status and for potentially carrying other control information.

Embodiments may define the expected behavior of STAs after receiving an initial control frame from the AP based on the downlink data availability status for the STAs. For example, if the initial control frame indicates transmitted by the AP indicates that the AP has downlink data to transmit to a particular STA, the STA may perform DSO subband switching (i.e., switch from operating in a non-DSO (primary) subband to operating in the designated DSO subband) and transmit an initial control response frame (ICR) to the AP regardless of whether the STA has uplink data to transmit to the AP or not. Otherwise, if the initial control frame indicates that the AP does not have any downlink data to transmit to a particular STA, the STA may determine whether to perform DSO subband switching depending on whether the STA has uplink data to transmit to the AP. If the STA has uplink data to transmit to the AP, the STA may perform DSO subband switching and transmit an initial control response frame to the AP. Otherwise, if the STA does not have any uplink data to transmit to the AP (which means this is a case where the AP does not have any downlink data to transmit to the STA and the STA does not have any uplink data to transmit to the AP), the STA may remain operating in the non-DSO subband (does not perform DSO subband switching) and refrain from responding to the initial control frame.

The AP may determine the uplink data availability and the DSO subband switching status of the STAs based on the responses received from the STAs (or lack of response). For example, if the initial control frame transmitted by the AP indicated that the AP did not have any downlink data to transmit to a particular STA and the AP receives an initial control frame from the STA, the AP may infer that the STA has uplink data to transmit to the AP and has performed DSO subband switching. If the initial control frame transmitted by the AP indicated that the AP did not have any downlink data to transmit to a particular STA and the AP does not receive a response from the STA, the AP may infer that the STA does not have any uplink data to transmit to the AP and will not perform DSO subband switching.

In an embodiment, during a DSO operation period, STAs that did not perform DSO subbaand switching (e.g., due to not having any downlink data to receive or any uplink data to transmit at the time that the AP transmitted the initial control frame) may transmit uplink data to the AP via uplink orthogonal frequency division multiple access random access (UORA), for example, if uplink data arrived at the STA after the AP transmitted the initial control frame. The UORA operation may only be allowed in the primary channel/subband to allow for efficient DSO subband utilization. The orthogonal frequency division multiple access backoff (OBO) counter used by non-switching STAs for UORA may be adjusted to improve RA-RU (random access resource unit) occupancy during UORA operations.

For purposes of illustration, various embodiments are described herein in the context of wireless networks that are based on IEEE 802.11 standards and using terminology and concepts thereof. Those skilled in the art will appreciate that the embodiments disclosed herein can be modified/adapted for use in other types of wireless networks.

In the following detailed description, only certain embodiments of the present invention have been shown and described, simply by way of illustration. As those skilled in the art would realize, the described embodiments may be modified in different ways, all without departing from the spirit or scope of the present invention. Accordingly, the drawings and description are to be regarded as illustrative in nature and not restrictive. Like reference numerals designate like elements throughout the specification.

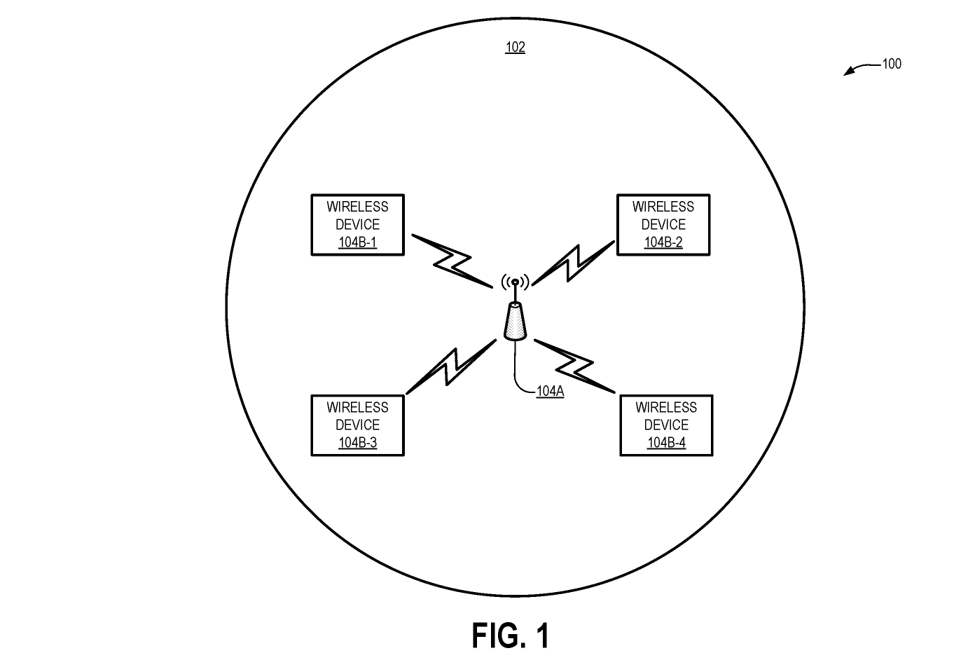

FIG. 1 shows a wireless local area network (WLAN) 100 with a basic service set (BSS) 102 that includes a plurality of wireless devices 104 (sometimes referred to as WLAN devices 104). Each of the wireless devices 104 may include a medium access control (MAC) layer and a physical (PHY) layer according to an IEEE (Institute of Electrical and Electronics Engineers) standard 802.11, including one or more of the amendments (e.g., 802.11a/b/g/n/p/ac/ax/bd/be). In one embodiment, the MAC layer of a wireless device 104 may initiate transmission of a frame to another wireless device 104 by passing a PHY-TXSTART.request (TXVECTOR) to the PHY layer. The TXVECTOR provides parameters for generating and/or transmitting a corresponding frame. Similarly, a PHY layer of a receiving wireless device may generate an RXVECTOR, which includes parameters of a received frame and is passed to a MAC layer for processing.

The plurality of wireless devices 104 may include a wireless device 104A that is an access point (sometimes referred to as an AP station or AP STA) and the other wireless devices 104B₁-104B₄ that are non-AP stations (sometimes referred to as non-AP STAs). Alternatively, all the plurality of wireless devices 104 may be non-AP STAs in an ad-hoc networking environment. In general, the AP STA (e.g., wireless device 104A) and the non-AP STAs (e.g., wireless devices 104B₁-104B₄) may be collectively referred to as STAs. However, for ease of description, only the non-AP STAs may be referred to as STAs unless the context indicates otherwise. Although shown with four non-AP STAs (e.g., the wireless devices 104B₁-104B₄), the WLAN 100 may include any number of non-AP STAs (e.g., one or more wireless devices 104B).

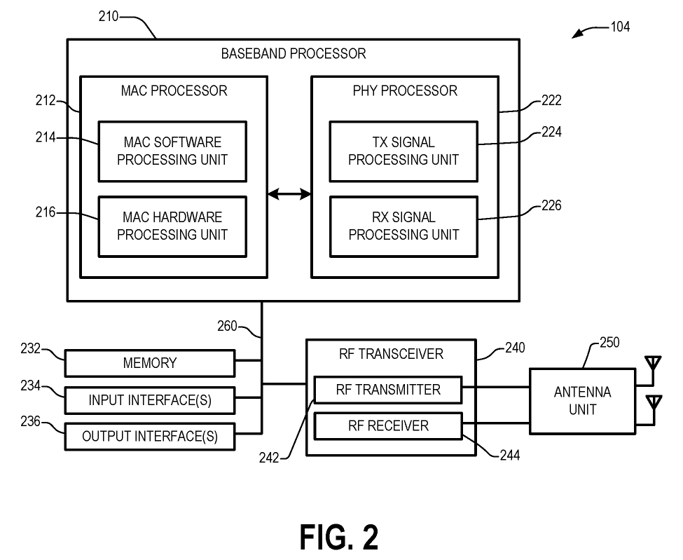

FIG. 2 illustrates a schematic block diagram of a wireless device 104, according to an embodiment. The wireless device 104 may be the wireless device 104A (i.e., the AP of the WLAN 100) or any of the wireless devices 104B₁-104B₄ in FIG. 1. The wireless device 104 includes a baseband processor 210, a radio frequency (RF) transceiver 240, an antenna unit 250, a storage device (e.g., memory device) 232, one or more input interfaces 234, and one or more output interfaces 236. The baseband processor 210, the storage device 232, the input interfaces 234, the output interfaces 236, and the RF transceiver 240 may communicate with each other via a bus 260.

The baseband processor 210 performs baseband signal processing and includes a MAC processor 212 and a PHY processor 222. The baseband processor 210 may utilize the memory 232, which may include a non-transitory computer/machine readable medium having software (e.g., computer/machine programing instructions) and data stored therein.

In an embodiment, the MAC processor 212 includes a MAC software processing unit 214 and a MAC hardware processing unit 216. The MAC software processing unit 214 may implement a first plurality of functions of the MAC layer by executing MAC software, which may be included in the software stored in the storage device 232. The MAC hardware processing unit 216 may implement a second plurality of functions of the MAC layer in special-purpose hardware. However, the MAC processor 212 is not limited thereto. For example, the MAC processor 212 may be configured to perform the first and second plurality of functions entirely in software or entirely in hardware according to an implementation.

The PHY processor 222 includes a transmitting (TX) signal processing unit (SPU) 224 and a receiving (RX) SPU 226. The PHY processor 222 implements a plurality of functions of the PHY layer. These functions may be performed in software, hardware, or a combination thereof according to an implementation.

Functions performed by the transmitting SPU 224 may include one or more of Forward Error Correction (FEC) encoding, stream parsing into one or more spatial streams, diversity encoding of the spatial streams into a plurality of space-time streams, spatial mapping of the space-time streams to transmit chains, inverse Fourier Transform (iFT) computation, Cyclic Prefix (CP) insertion to create a Guard Interval (GI), and the like. Functions performed by the receiving SPU 226 may include inverses of the functions performed by the transmitting SPU 224, such as GI removal, Fourier Transform computation, and the like.

The RF transceiver 240 includes an RF transmitter 242 and an RF receiver 244. The RF transceiver 240 is configured to transmit first information received from the baseband processor 210 to the WLAN 100 (e.g., to another WLAN device 104 of the WLAN 100) and provide second information received from the WLAN 100 (e.g., from another WLAN device 104 of the WLAN 100) to the baseband processor 210.

The antenna unit 250 includes one or more antennas. When Multiple-Input Multiple-Output (MIMO) or Multi-User MIMO (MU-MIMO) is used, the antenna unit 250 may include a plurality of antennas. In an embodiment, the antennas in the antenna unit 250 may operate as a beam-formed antenna array. In an embodiment, the antennas in the antenna unit 250 may be directional antennas, which may be fixed or steerable.

The input interfaces 234 receive information from a user, and the output interfaces 236 output information to the user. The input interfaces 234 may include one or more of a keyboard, keypad, mouse, touchscreen, microphone, and the like. The output interfaces 236 may include one or more of a display device, touch screen, speaker, and the like.

As described herein, many functions of the WLAN device 104 may be implemented in either hardware or software. Which functions are implemented in software and which functions are implemented in hardware will vary according to constraints imposed on a design. The constraints may include one or more of design cost, manufacturing cost, time to market, power consumption, available semiconductor technology, etc.

As described herein, a wide variety of electronic devices, circuits, firmware, software, and combinations thereof may be used to implement the functions of the components of the WLAN device 104. Furthermore, the WLAN device 104 may include other components, such as application processors, storage interfaces, clock generator circuits, power supply circuits, and the like, which have been omitted in the interest of brevity.

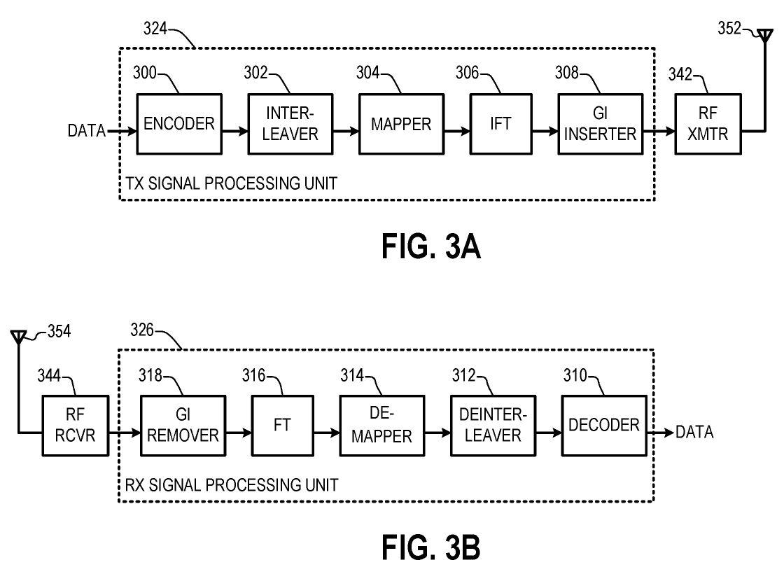

FIG. 3A illustrates components of a WLAN device 104 configured to transmit data according to an embodiment, including a transmitting (Tx) SPU (TxSP) 324, an RF transmitter 342, and an antenna 352. In an embodiment, the TxSP 324, the RF transmitter 342, and the antenna 352 correspond to the transmitting SPU 224, the RF transmitter 242, and an antenna of the antenna unit 250 of FIG. 2, respectively.

The TxSP 324 includes an encoder 300, an interleaver 302, a mapper 304, an inverse Fourier transformer (IFT) 306, and a guard interval (GI) inserter 308.

The encoder 300 receives and encodes input data. In an embodiment, the encoder 300 includes a forward error correction (FEC) encoder. The FEC encoder may include a binary convolution code (BCC) encoder followed by a puncturing device. The FEC encoder may include a low-density parity-check (LDPC) encoder.

The TxSP 324 may further include a scrambler for scrambling the input data before the encoding is performed by the encoder 300 to reduce the probability of long sequences of 0s or 1s. When the encoder 300 performs the BCC encoding, the TxSP 324 may further include an encoder parser for demultiplexing the scrambled bits among a plurality of BCC encoders. If LDPC encoding is used in the encoder, the TxSP 324 may not use the encoder parser.

The interleaver 302 interleaves the bits of each stream output from the encoder 300 to change an order of bits therein. The interleaver 302 may apply the interleaving only when the encoder 300 performs BCC encoding and otherwise may output the stream output from the encoder 300 without changing the order of the bits therein.

The mapper 304 maps the sequence of bits output from the interleaver 302 to constellation points. If the encoder 300 performed LDPC encoding, the mapper 304 may also perform LDPC tone mapping in addition to constellation mapping.

When the TxSP 324 performs a MIMO or MU-MIMO transmission, the TxSP 324 may include a plurality of interleavers 302 and a plurality of mappers 304 according to a number of spatial streams (NSS) of the transmission. The TxSP 324 may further include a stream parser for dividing the output of the encoder 300 into blocks and may respectively send the blocks to different interleavers 302 or mappers 304. The TxSP 324 may further include a space-time block code (STBC) encoder for spreading the constellation points from the spatial streams into a number of space-time streams (NSTS) and a spatial mapper for mapping the space-time streams to transmit chains. The spatial mapper may use direct mapping, spatial expansion, or beamforming.

The IFT 306 converts a block of the constellation points output from the mapper 304 (or, when MIMO or MU-MIMO is performed, the spatial mapper) to a time domain block (i.e., a symbol) by using an inverse discrete Fourier transform (IDFT) or an inverse fast Fourier transform (IFFT). If the STBC encoder and the spatial mapper are used, the IFT 306 may be provided for each transmit chain.

When the TxSP 324 performs a MIMO or MU-MIMO transmission, the TxSP 324 may insert cyclic shift diversities (CSDs) to prevent unintentional beamforming. The TxSP 324 may perform the insertion of the CSD before or after the IFT 306. The CSD may be specified per transmit chain or may be specified per space-time stream. Alternatively, the CSD may be applied as a part of the spatial mapper.

When the TxSP 324 performs a MIMO or MU-MIMO transmission, some blocks before the spatial mapper may be provided for each user.

The GI inserter 308 prepends a GI to each symbol produced by the IFT 306. Each GI may include a Cyclic Prefix (CP) corresponding to a repeated portion of the end of the symbol that the GI precedes. The TxSP 324 may optionally perform windowing to smooth edges of each symbol after inserting the GI.

The RF transmitter 342 converts the symbols into an RF signal and transmits the RF signal via the antenna 352. When the TxSP 324 performs a MIMO or MU-MIMO transmission, the GI inserter 308 and the RF transmitter 342 may be provided for each transmit chain.

FIG. 3B illustrates components of a WLAN device 104 configured to receive data according to an embodiment, including a Receiver (Rx) SPU (RxSP) 326, an RF receiver 344, and an antenna 354. In an embodiment, the RxSP 326, RF receiver 344, and antenna 354 may correspond to the receiving SPU 226, the RF receiver 244, and an antenna of the antenna unit 250 of FIG. 2, respectively.

The RxSP 326 includes a GI remover 318, a Fourier transformer (FT) 316, a demapper 314, a deinterleaver 312, and a decoder 310.

The RF receiver 344 receives an RF signal via the antenna 354 and converts the RF signal into symbols. The GI remover 318 removes the GI from each of the symbols. When the received transmission is a MIMO or MU-MIMO transmission, the RF receiver 344 and the GI remover 318 may be provided for each receive chain.

The FT 316 converts each symbol (that is, each time domain block) into a frequency domain block of constellation points by using a discrete Fourier transform (DFT) or a fast Fourier transform (FFT). The FT 316 may be provided for each receive chain.

When the received transmission is the MIMO or MU-MIMO transmission, the RxSP 326 may include a spatial demapper for converting the respective outputs of the FTs 316 of the receiver chains to constellation points of a plurality of space-time streams, and an STBC decoder for despreading the constellation points from the space-time streams into one or more spatial streams.

The demapper 314 demaps the constellation points output from the FT 316 or the STBC decoder to bit streams. If the received transmission was encoded using LDPC encoding, the demapper 314 may further perform LDPC tone demapping before performing the constellation demapping.

The deinterleaver 312 deinterleaves the bits of each stream output from the demapper 314. The deinterleaver 312 may perform the deinterleaving only when the received transmission was encoded using BCC encoding, and otherwise may output the stream output by the demapper 314 without performing deinterleaving.

When the received transmission is the MIMO or MU-MIMO transmission, the RxSP 326 may use a plurality of demappers 314 and a plurality of deinterleavers 312 corresponding to the number of spatial streams of the transmission. In this case, the RxSP 326 may further include a stream deparser for combining the streams output from the deinterleavers 312.

The decoder 310 decodes the streams output from the deinterleaver 312 or the stream deparser. In an embodiment, the decoder 310 includes an FEC decoder. The FEC decoder may include a BCC decoder or an LDPC decoder.

The RxSP 326 may further include a descrambler for descrambling the decoded data. When the decoder 310 performs BCC decoding, the RxSP 326 may further include an encoder deparser for multiplexing the data decoded by a plurality of BCC decoders. When the decoder 310 performs the LDPC decoding, the RxSP 326 may not use the encoder deparser.

Before making a transmission, wireless devices such as wireless device 104 will assess the availability of the wireless medium using Clear Channel Assessment (CCA). If the medium is occupied, CCA may determine that it is busy, while if the medium is available, CCA determines that it is idle.

The PHY entity for IEEE 802.11 is based on Orthogonal Frequency Division Multiplexing (OFDM) or Orthogonal Frequency Division Multiple Access (OFDMA). In either OFDM or OFDMA Physical (PHY) layers, a STA (e.g., a wireless device 104) is capable of transmitting and receiving Physical Layer (PHY) Protocol Data Units (PPDUs) (also referred to as PLCP (Physical Layer Convergence Procedure) Protocol Data Units) that are compliant with the mandatory PHY specifications. A PHY specification defines a set of Modulation and Coding Schemes (MCS) and a maximum number of spatial streams. Some PHY entities define downlink (DL) and uplink (UL) Multi-User (MU) transmissions having a maximum number of space-time streams (STS) per user and employing up to a predetermined total number of STSs. A PHY entity may provide support for 10 Megahertz (MHz), 20 MHz, 40 MHz, 80 MHz, 160 MHz, 240 MHz, and 320 MHz contiguous channel widths and support for an 80+80, 80+160 MHz, and 160+160 MHz non-contiguous channel width. Each channel includes a plurality of subcarriers, which may also be referred to as tones. A PHY entity may define signaling fields denoted as Legacy Signal (L-SIG), Signal A (SIG-A), and Signal B (SIG-B), and the like within a PPDU by which some necessary information about PHY Service Data Unit (PSDU) attributes are communicated. The descriptions below, for sake of completeness and brevity, refer to OFDM-based 802.11 technology. Unless otherwise indicated, a station refers to a non-AP STA.

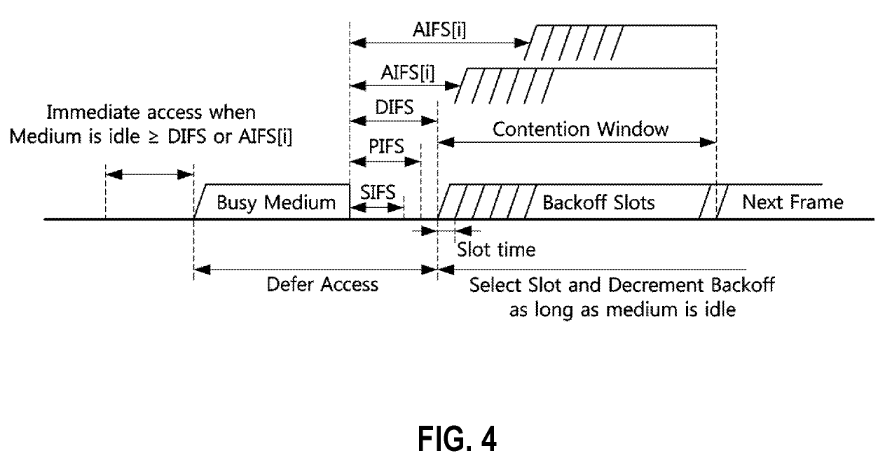

FIG. 4 illustrates Inter-Frame Space (IFS) relationships. In particular, FIG. 4 illustrates a Short IFS (SIFS), a Point Coordination Function (PCF) IFS (PIFS), a Distributed Coordination Function (DCF) IFS (DIFS), and an Arbitration IFSs corresponding to an Access Category (AC) ‘i’ (AIFS[i]). FIG. 4 also illustrates a slot time and a data frame is used for transmission of data forwarded to a higher layer. As shown, a WLAN device 104 transmits the data frame after performing backoff if a DIFS has elapsed during which the medium has been idle.

A management frame may be used for exchanging management information, which is not forwarded to the higher layer. Subtype frames of the management frame include a beacon frame, an association request/response frame, a probe request/response frame, and an authentication request/response frame.

A control frame may be used for controlling access to the medium. Subtype frames of the control frame include a request to send (RTS) frame, a clear to send (CTS) frame, and an acknowledgement (ACK) frame.

When the control frame is not a response frame of another frame, the WLAN device 104 transmits the control frame after performing backoff if a DIFS has elapsed during which the medium has been idle. When the control frame is the response frame of another frame, the WLAN device 104 transmits the control frame after a SIFS has elapsed without performing backoff or checking whether the medium is idle.

A WLAN device 104 that supports Quality of Service (QoS) functionality (that is, a QoS STA) may transmit the frame after performing backoff if an AIFS for an associated access category (AC) (i.e., AIFS[AC]) has elapsed. When transmitted by the QoS STA, any of the data frame, the management frame, and the control frame, which is not the response frame, may use the AIFS[AC] of the AC of the transmitted frame.

A WLAN device 104 may perform a backoff procedure when the WLAN device 104 that is ready to transfer a frame finds the medium busy. The backoff procedure includes determining a random backoff time composed of N backoff slots, where each backoff slot has a duration equal to a slot time and N being an integer number greater than or equal to zero. The backoff time may be determined according to a length of a Contention Window (CW). In an embodiment, the backoff time may be determined according to an AC of the frame. All backoff slots occur following a DIFS or Extended IFS (EIFS) period during which the medium is determined to be idle for the duration of the period.

When the WLAN device 104 detects no medium activity for the duration of a particular backoff slot, the backoff procedure shall decrement the backoff time by the slot time. When the WLAN device 104 determines that the medium is busy during a backoff slot, the backoff procedure is suspended until the medium is again determined to be idle for the duration of a DIFS or EIFS period. The WLAN device 104 may perform transmission or retransmission of the frame when the backoff timer reaches zero.

The backoff procedure operates so that when multiple WLAN devices 104 are deferring and execute the backoff procedure, each WLAN device 104 may select a backoff time using a random function and the WLAN device 104 that selects the smallest backoff time may win the contention, reducing the probability of a collision.

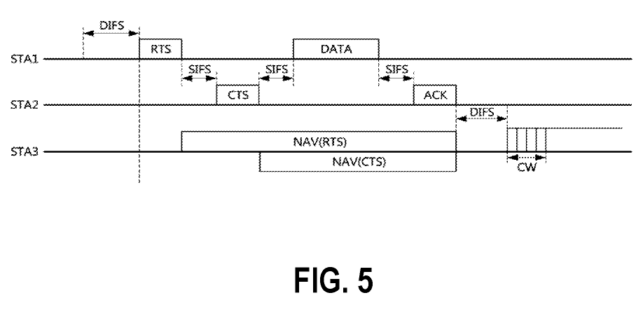

FIG. 5 illustrates a Carrier Sense Multiple Access/Collision Avoidance (CSMA/CA) based frame transmission procedure for avoiding collision between frames in a channel according to an embodiment. FIG. 5 shows a first station STA1 transmitting data, a second station STA2 receiving the data, and a third station STA3 that may be located in an area where a frame transmitted from the STA1 can be received, a frame transmitted from the second station STA2 can be received, or both can be received. The stations STA1, STA2, and STA3 may be WLAN devices 104 of FIG. 1.

The station STA1 may determine whether the channel is busy by carrier sensing. The station STA1 may determine channel occupation/status based on an energy level in the channel or an autocorrelation of signals in the channel, or may determine the channel occupation by using a network allocation vector (NAV) timer.

After determining that the channel is not used by other devices (that is, that the channel is IDLE) during a DIFS (and performing backoff if required), the station STA1 may transmit a Request-To-Send (RTS) frame to the station STA2. Upon receiving the RTS frame, after a SIFS the station STA2 may transmit a Clear-To-Send (CTS) frame as a response to the RTS frame. If Dual-CTS is enabled and the station STA2 is an AP, the AP may send two CTS frames in response to the RTS frame (e.g., a first CTS frame in a non-High Throughput format and a second CTS frame in the HT format).

When the station STA3 receives the RTS frame, it may set a NAV timer of the station STA3 for a transmission duration of subsequently transmitted frames (for example, a duration of SIFS + CTS frame duration + SIFS + data frame duration + SIFS + ACK frame duration) using duration information included in the RTS frame. When the station STA3 receives the CTS frame, it may set the NAV timer of the station STA3 for a transmission duration of subsequently transmitted frames using duration information included in the CTS frame. Upon receiving a new frame before the NAV timer expires, the station STA3 may update the NAV timer of the station STA3 by using duration information included in the new frame. The station STA3 does not attempt to access the channel until the NAV timer expires.

When the station STA1 receives the CTS frame from the station STA2, it may transmit a data frame to the station STA2 after a SIFS period elapses from a time when the CTS frame has been completely received. Upon successfully receiving the data frame, the station STA2 may transmit an ACK frame as a response to the data frame after a SIFS period elapses.

When the NAV timer expires, the third station STA3 may determine whether the channel is busy using the carrier sensing. Upon determining that the channel is not used by other devices during a DIFS period after the NAV timer has expired, the station STA3 may attempt to access the channel after a contention window elapses according to a backoff process.

When Dual-CTS is enabled, a station that has obtained a transmission opportunity (TXOP) and that has no data to transmit may transmit a CF-End frame to cut short the TXOP. An AP receiving a CF-End frame having a Basic Service Set Identifier (BSSID) of the AP as a destination address may respond by transmitting two more CF-End frames: a first CF-End frame using Space Time Block Coding (STBC) and a second CF-End frame using non-STBC. A station receiving a CF-End frame resets its NAV timer to 0 at the end of the PPDU containing the CF-End frame. FIG. 5 shows the station STA2 transmitting an ACK frame to acknowledge the successful reception of a frame by the recipient.

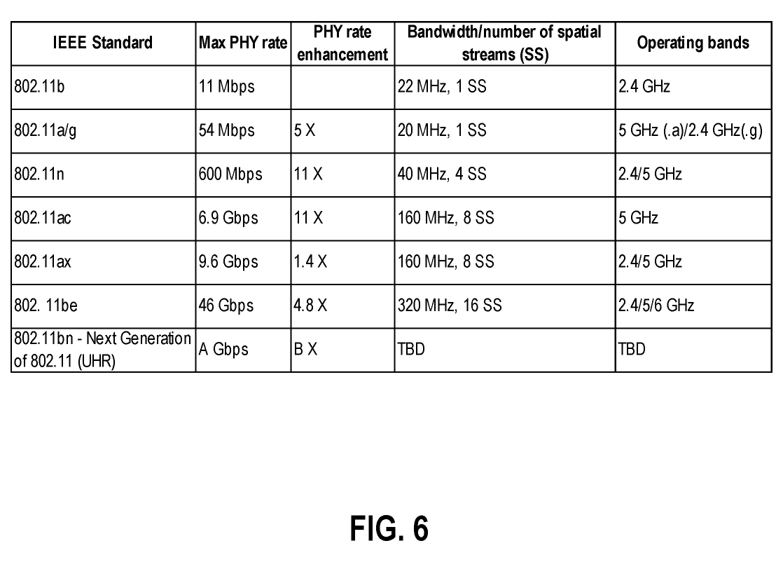

The IEEE 802.11bn (Ultra High Reliability, UHR) working group has been established to address the growing demand for higher peak throughput and reliability in Wi-Fi. As shown in FIG. 6, the peak PHY rate has significantly increased from IEEE 802.11b to IEEE 802.11be (Wi-Fi 7), with the latter focusing on further improving peak throughput. The UHR study group aims to enhance the tail of the latency distribution and jitter to support applications that require low latency, such as video-over-WLAN, gaming, AR, and VR. It is noted that various characteristics of UHR (e.g., max PHY rate, PHY rate enhancement, bandwidth/number of spatial streams, and operating bands) are still to be determined.

The focus of IEEE 802.11be is primarily on WLAN indoor and outdoor operation with stationary and pedestrian speeds in the 2.4, 5, and 6 GHz frequency bands. In addition to peak PHY rate, different candidate features are under discussion. These candidate features include (1) a 320MHz bandwidth and a more efficient utilization of a non-contiguous spectrum, (2) multi-band/multi-channel aggregation and operation, (3) 16 spatial streams and Multiple Input Multiple Output (MIMO) protocol enhancements, (4) multi-Access Point (AP) Coordination (e.g., coordinated and joint transmission), (5) an enhanced link adaptation and retransmission protocol (e.g., Hybrid Automatic Repeat Request (HARQ)), and (6) adaptation to regulatory rules specific to a 6 GHz spectrum.

The focus of IEEE 802.11bn (UHR) is still under discussion, with candidate features including MLO enhancements (e.g., in terms of increased throughput/reliability and decreased latency), latency and reliability improvements (e.g., multi-AP coordination to support low latency traffic), bandwidth expansion (e.g., to 240, 480, 640 MHz), aggregated PPDU (A-PPDU), enhanced multi-link single-radio (eMLSR) extensions to AP, roaming improvements, and power-saving schemes for prolonging battery life.

Some features, such as increasing the bandwidth and the number of spatial streams, are solutions that have been proven to be effective in previous projects focused on increasing link throughput and on which feasibility demonstration is achievable.

With respect to operational bands (e.g., 2.4/5/6 GHz) for IEEE 802.11be, more than 1 GHz of additional unlicensed spectrum is likely to be available because the 6 GHz band (5.925– 7.125 GHz) is being considered for unlicensed use. This would allow APs and STAs to become tri-band devices. Larger than 160MHz data transmissions (e.g., 320 MHz or 640 MHz) could be considered to increase the maximum PHY rate. For example, 320 MHz or 160+160MHz data could be transmitted in the 6 GHz band. For example, 160+160 MHz data could be transmitted across the 5 and 6 GHz bands.

In the process of wireless communication, a transmitting station (STA) creates a Physical Layer Protocol Data Unit (PPDU) frame and sends it to a receiving STA. The receiving STA then receives, detects, and processes the PPDU.

The Extremely High Throughput (EHT) PPDU frame encompasses several components. It includes a legacy part, which comprises fields such as the Legacy Short Training Field (L-STF), Legacy Long Training Field (L-LTF), Legacy Signal Field (L-SIG), and Repeated Legacy Signal Field (RL-SIG). These fields are used to maintain compatibility with older Wi-Fi standards.

In addition to the legacy part, the EHT PPDU frame also contains the Universal Signal Field (U-SIG), EHT Signal Field (EHT-SIG), EHT Short Training Field (EHT-STF), and EHT Long Training Field (EHT-LTF). These fields are specific to the EHT standard and are used for various purposes, such as signaling, synchronization, and channel estimation.

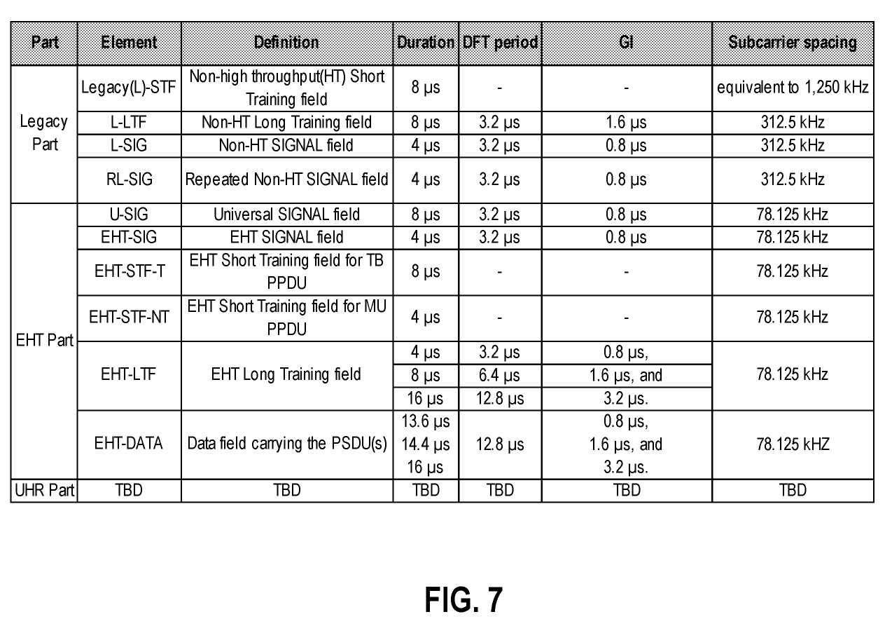

FIG. 7 provides a more detailed description of each field in the EHT PPDU frame, including their purposes and characteristics.

Regarding the Ultra High Reliability (UHR) PPDU, its frame structure is currently undefined and will be determined through further discussions within the relevant working group or study group. This indicates that the specifics of the UHR PPDU are still under development and will be finalized based on the outcomes of future deliberations.

The distributed nature of channel access networks, such as IEEE 802.11 WLANs, makes the carrier sense mechanism useful for ensuring collision-free operation. Each station (STA) uses its physical carrier sense to detect transmissions from other STAs. However, in certain situations, it may not be possible for a STA to detect every transmission. For instance, when one STA is located far away from another STA, it might perceive the medium as idle and start transmitting a frame, leading to collisions. To mitigate this hidden node problem, the network allocation vector (NAV) has been introduced.

As the IEEE 802.11 standard continues to evolve, it now includes scenarios where multiple users can simultaneously transmit or receive data within a basic service set (BSS), such as uplink (UL) and downlink (DL) multi-user (MU) transmissions in a cascaded manner. In these cases, the existing carrier sense and NAV mechanisms may not be sufficient, and modifications or newly defined mechanisms may be required to facilitate efficient and collision-free operation.

For the purpose of this disclosure, MU transmission refers to situations where multiple frames are transmitted to or from multiple STAs simultaneously using different resources. Examples of these resources include different frequency resources in Orthogonal Frequency Division Multiple Access (OFDMA) transmission and different spatial streams in Multi-User Multiple Input Multiple Output (MU-MIMO) transmission. Consequently, downlink OFDMA (DL-OFDMA), downlink MU-MIMO (DL-MU-MIMO), uplink OFDMA (UL-OFDMA), uplink MU-MIMO (UL-MU-MIMO), and OFDMA with MU-MIMO are all considered examples of MU transmission.

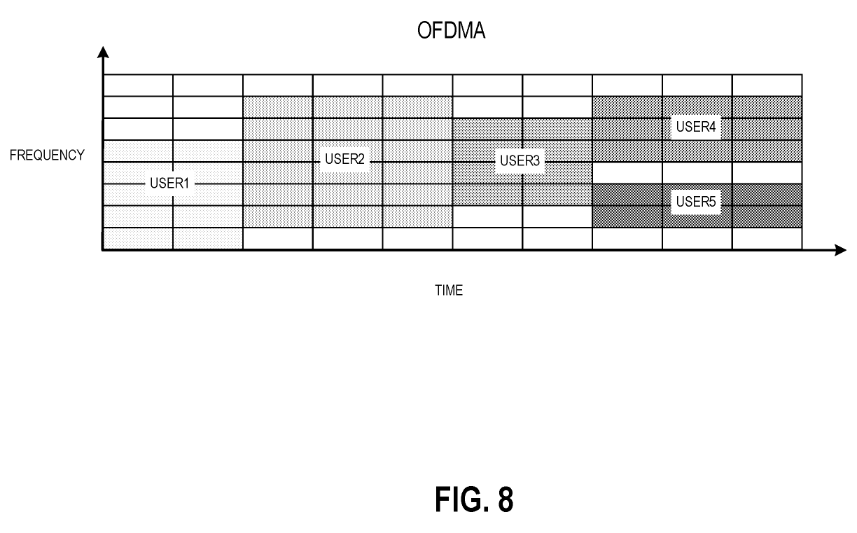

FIG. 8 illustrates an example of multi-user (MU) transmission in Orthogonal Frequency-Division Multiple Access (OFDMA), in accordance with some embodiments of the present disclosure.

In the IEEE 802.11ax and 802.11be specifications, the trigger frame plays a useful role in facilitating uplink multi-user (MU) transmissions. The purpose of the trigger frame is to allocate resources and solicit one or more Trigger-based (TB) Physical Layer Protocol Data Unit (PPDU) transmissions from the associated stations (STAs).

The trigger frame contains information required by the responding STAs to send their Uplink TB PPDUs. This information includes the Trigger type, which specifies the type of TB PPDU expected, and the Uplink Length (UL Length), which indicates the duration of the uplink transmission.

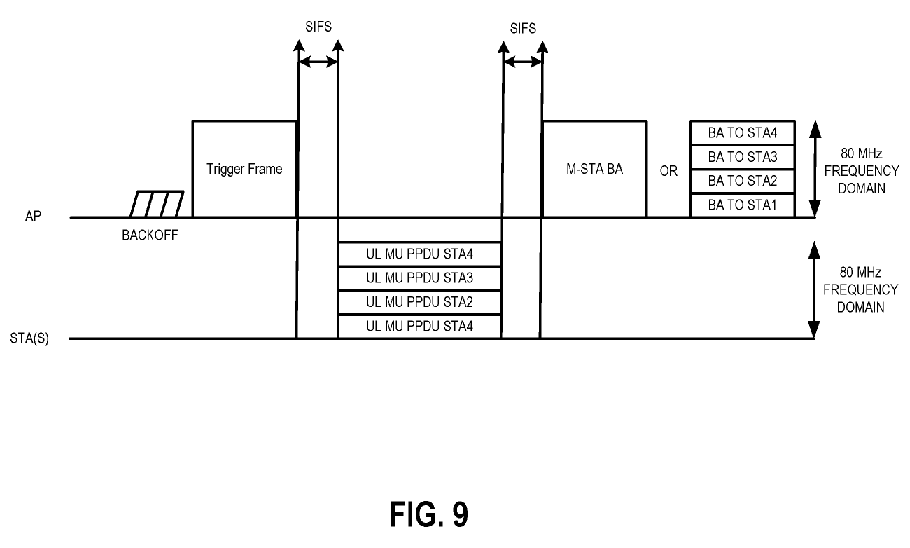

FIG. 9 illustrates an example scenario where an access point (AP) operating in an 80MHz bandwidth environment sends a Trigger frame to multiple associated STAs. Upon receiving the Trigger frame, the STAs respond by sending their respective Uplink Orthogonal Frequency Division Multiple Access (UL OFDMA) TB PPDUs, utilizing the allocated resources within the specified 80 MHz bandwidth.

After successfully receiving the UL OFDMA TB PPDUs, the AP acknowledges the STAs by sending an acknowledgement frame. This acknowledgement can be in the form of an 80MHz width multi-STA Block Acknowledgement (Block Ack) or a Block Acknowledgement with a Direct Feedback (DF) OFDMA method. The multi-STA Block Ack allows the AP to acknowledge multiple STAs simultaneously, while the Block Ack with DF OFDMA enables the AP to provide feedback to the STAs using the same OFDMA technique employed in the uplink transmission.

The trigger frame is a useful component in enabling efficient uplink MU transmissions in IEEE 802.11ax and 802.11be networks, by allocating resources and coordinating the uplink transmissions from multiple STAs within the same bandwidth.

Wireless network systems can rely on retransmission of media access control (MAC) protocol data units (MPDUs) when the transmitter (TX) does not receive an acknowledgement from the receiver (RX) or MPDUs are not successfully decoded by the receiver. Using an automatic repeat request (ARQ) approach, the receiver discards the last failed MPDU before receiving the newly retransmitted MPDU. With requirements of enhanced reliability and reduced latency, the wireless network system can evolve toward a hybrid ARQ (HARQ) approach.

There are two methods of HARQ processing. In a first type of HARQ scheme, also referred to as chase combining (CC) HARQ (CC-HARQ) scheme, signals to be retransmitted are the same as the signals that previously failed because all subpackets to be retransmitted use the same puncturing pattern. The puncturing is needed to remove some of the parity bits after encoding using an error-correction code. The reason why the same puncturing pattern is used with CC-HARQ is to generate a coded data sequence with forward error correction (FEC) and to make the receiver use a maximum-ratio combining (MRC) to combine the received, retransmitted bits with the same bits from the previous transmission. For example, information sequences are transmitted in packets with a fixed length. At a receiver, error correction and detection are carried out over the whole packet. However, the ARQ scheme may be inefficient in the presence of burst errors. To solve this more efficiently, subpackets are used. In subpacket transmissions, only those subpackets that include errors need to be retransmitted.

Since the receiver uses both the current and the previously received subpackets for decoding data, the error probability in decoding decreases as the number of used subpackets increases. The decoding process passes a cyclic redundancy check (CRC) and ends when the entire packet is decoded without error or the maximum number of subpackets is reached. In particular, this scheme operates on a stop-and-wait protocol such that if the receiver can decode the packet, it sends an acknowledgement (ACK) to the transmitter. When the transmitter receives an ACK successfully, it terminates the HARQ transmission of the packet. If the receiver cannot decode the packet, it sends a negative acknowledgement (NAK) to the transmitter and the transmitter performs the retransmission process.

In a second type of HARQ scheme, also referred to as an incremental redundancy (IR) HARQ (IR-HARQ) scheme, different puncturing patterns are used for each subpacket such that the signal changes for each retransmitted subpacket in comparison to the originally transmitted subpacket. IR-HARQ alternatively uses two puncturing patterns for odd numbered and even numbered transmissions, respectively. The redundancy scheme of IR-HARQ improves the log likelihood ratio (LLR) of parity bit(s) in order to combine information sent across different transmissions due to requests and lowers the code rate as the additional subpacket is used. This results in a lower error rate of the subpacket in comparison to CC-HARQ. The puncturing pattern used in IR-HARQ is indicated by a subpacket identity (SPID) indication. The SPID of the first subpacket may always be set to 0 and all the systematic bits and the punctured parity bits are transmitted in the first subpacket. Self-decoding is possible when the receiving signal-to-noise ratio (SNR) environment is good (i.e., a high SNR). In some embodiments, subpackets with corresponding SPIDs to be transmitted are in increasing order of SPID but can be exchanged/switched except for the first SPID.

AP coordination has been considered as a potential technology to improve WLAN system throughput in the IEEE 802.11be standard and is still being discussed in the IEEE 802.11bn (UHR) standard. To support various AP coordination schemes, such as coordinated beamforming, OFDMA, TDMA, spatial reuse, and joint transmission, a predefined mechanism for APs is necessary.

In the context of coordinated TDMA (co-TDMA or c-TDMA), the AP that obtains a transmit opportunity (TXOP) is referred to as the sharing AP. This AP initiates the AP coordination schemes to determine the AP candidate set by sending a frame, such as a Beacon frame or probe response frame, which includes information about the AP coordination scheme capabilities. The AP that participates in the AP coordination schemes after receiving the frame from the sharing AP is called the shared AP. The sharing AP is also known as the master AP or coordinating AP, while the shared AP is referred to as the slave AP or coordinated AP.

The operation of various AP coordination schemes has been discussed in the IEEE 802.11be and UHR standards:

Coordinated Beamforming (Co-BF or C-BF): Multiple APs transmit on the same frequency resource by coordinating and forming spatial nulls, allowing for simultaneous transmission from multiple APs.

Coordinated OFDMA (Co-OFDMA or C-OFDMA): APs transmit on orthogonal frequency resources by coordinating and splitting the spectrum, enabling more efficient spectrum utilization.

Joint Transmission (JTX): Multiple APs transmit jointly to a given user simultaneously by sharing data between the APs.

Coordinated Spatial Reuse (Co-SR or C-SR): Multiple APs or STAs adjust their transmit power to reduce interference between APs.

By implementing these AP coordination schemes, WLAN systems can improve their overall throughput and efficiency by leveraging the cooperation between multiple APs.

DSO is a feature that allows a non-access point station (non-AP STA) that is capable of DSO (hereinafter referred to as a DSO-capable STA or DSO STA) to be dynamically allocated bandwidth outside of its current operating bandwidth on a per-transmission opportunity (per-TXOP) basis, as long as it is within the associated AP's operating bandwidth. DSO is designed to enhance the overall bandwidth utilization in the BSS.

DSO addresses inefficiencies caused by the difference in maximum supported bandwidth (BW) between access points APs and non-AP STAs. For example, in the IEEE 802.11be (also referred to as Extremely High Throughput or EHT) wireless networking standard (which is the wireless networking standard prior to IEEE 802.11bn (also referred to as Ultra High Reliability or UHR), currently under development), a single link could support up to a 320 MHz bandwidth, but it is expected that UHR APs will be able to support even wider bandwidths. It is expected that UHR non-AP STAs will support a maximum bandwidth of 160 MHz, 80 MHz, or less. This mismatch between the bandwidth capabilities of APs and non-AP STAs can lead to the underutilization of the AP's available bandwidth resources. For example, even though an AP supports a maximum bandwidth of 320 MHz, it might only use 160 MHz of its bandwidth to serve a non-AP STA that supports a maximum bandwidth of 160 MHz, thus leaving the remaining 160 MHz bandwidth unused. DSO allows the AP to utilize the remaining 160 MHz bandwidth to transmit/receive to/from other non-AP STA(s).

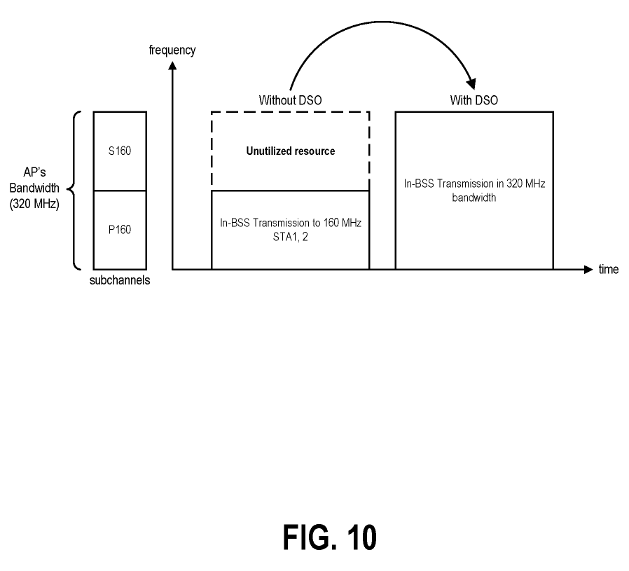

FIG. 10 is a diagram showing the concept of DSO, according to some embodiments.

The example shown in the diagram assumes that a wireless network includes an AP and two non-AP STAs (STA1 and STA2). The AP may support a bandwidth of up to 320 MHz. STA1 and STA2 may support a bandwidth of up to 160 MHz. As shown in the diagram, the AP may begin communicating with STA1 and STA2 in a 160 MHz bandwidth (in the primary 160 MHz (P160) channel). However, in this case, the AP cannot fully utilize its available bandwidth capacity of 320 MHz. That is, the secondary 160 MHz (S160) channel goes unutilized (depicted in the diagram as “Unutilized resource”).

DSO may be used to better utilize the available bandwidth. For example, with DSO, the AP may assign STA1 to the lower 160 MHz portion of the 320 MHz bandwidth (the P160 channel) and assign STA2 to the upper 160 MHz portion of the 320 MHz bandwidth (the S160 channel), thereby utilizing the entire 320 MHz bandwidth (depicted in the diagram as “In-BSS transmission in 320 MHz bandwidth”). It would also be possible to assign STA1 to the S160 channel but it is assumed in this example that STA1 does not support DSO so it is assigned to the P160 channel. In this case, STA2 supports DSO so it may be considered as a DSO STA or DSO-capable STA.

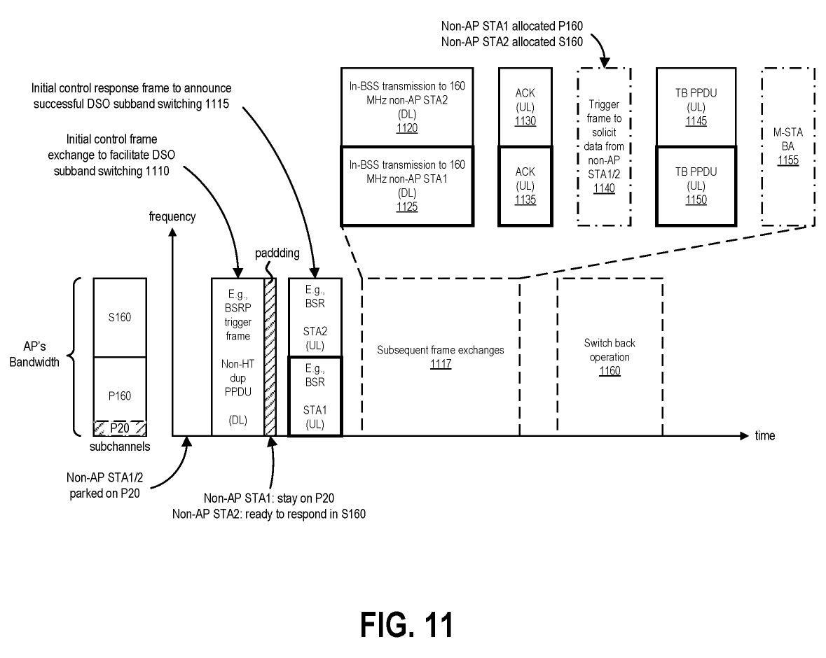

FIG. 11 is a diagram showing a frame exchange for performing DSO, according to some embodiments.

In the example shown in the diagram, it is assumed that the AP forms/operates a BSS that includes a first non-AP STA (STA1) and a second non-AP STA (STA2), and that only STA2 is capable of performing DSO (STA1 is not capable of performing DSO). That is, STA2 is a DSO-capable STA. The AP may support a maximum bandwidth of 320 MHz, whereas STA1 and STA2 may support a maximum bandwidth of 160 MHz.

To initiate DSO, the AP may transmit an initial control frame 1110 (ICF) to STA1 and STA2. In an embodiment, the initial control frame is a buffer status report poll (BSRP) frame. The initial control frame may include DSO-related information such as which DSO subband is being assigned for DSO and which RU(s) within the DSO subband is being assigned for DSO. For example, the initial control frame 1110 may include a STA ID (STAID) or a list of STA IDs (STAID list), RU allocation information (RU_ALLOCATION), DSO subband switching information, and/or bandwidth information. The initial control frame 1110 may be transmitted in a non-high throughput (non-HT) duplicate PPDU format. Also, the initial control frame 1110 may include padding to provide time for any non-AP STAs to perform DSO subband switching.

Upon receiving the initial control frame 1110 from the AP, STA1 and STA2 may behave as follows. Based on the information included in the initial control frame 1110, STA1 may remain operating in the P160 channel and transmit an initial control response frame (ICR) to the AP in the P160 channel. In an embodiment, this initial control response frame is a buffer status report (BSR) frame. Also, based on the information included in the initial control frame 1110, STA2 may perform DSO subband switching by switching from operating in the P160 channel to operating in the S160 channel, and transmit an initial control response frame 1115 to the AP in the S160 channel to announce successful DSO subband switching. In an embodiment, this initial control response frame 1115 is a BSR frame.

The initial control response frames transmitted by STA1 and STA2 may indicate the DSO subband switching status. For example, the initial control response frame transmitted by STA1 may indicate that STA1 remained in place (remained operating in the P160 channel) without performing DSO subband switching, while the initial control response frame 1115 transmitted by STA2 may indicate that STA2 successfully completed DSO subband switching (to the S160 channel). In addition, the initial control frames may include information requested by the AP in the initial control frame 1110. For example, if the initial control frame 1110 is a BSRP frame and the initial control response frame is a BSR frame, the initial control response frames (BSR frames) may indicate the amount of buffered data at the STA or be accompanied by a MAC protocol data unit (MPDU) (e.g., through aggregation) that includes the requested information.

Upon receiving the initial control response frames from STA1 and STA2, the AP may fully utilize the 320 MHz bandwidth during the upcoming DSO operation period (e.g., the DSO operation period may have been indicated in a MAC field of initial control frame 1110) by simultaneously communicating with STA2 in the S160 channel via DSO, and communicating with STA1 in the P160 channel, which remained in place and did not perform DSO subband switching (without requiring a separate DSO negotiation for STA1). For example, the AP may perform subsequent frame exchanges 1117 with STA1 and STA2, which may involve the AP performing an in-BSS downlink (DL) transmission 1125 to STA1 in the P160 channel and performing an in-BSS DL transmission 1120 to STA2 in the S160 channel (simultaneously). Frame exchanges 1117 may further involve STA1 and STA2 transmitting uplink (UL) acknowledgement (ACK) frames 1135 and 1130 to the AP in the P160 channel and S160 channel, respectively. Frame exchanges 1117 may further involve the AP transmitting a trigger frame 1140 to STA1 and STA2 (where the trigger frame allocates the P160 channel to STA1 and allocates the S160 channel to STA2) and STA1 and STA2 transmitting trigger-based (TB) uplink (UL) PPDU 1150 and TB UL PPDU 1145 to the AP in the P160 channel and the S160 channel, respectively (in accordance with the allocation indicated in the trigger frame 1140). Frame exchanges 1117 may further involve the AP transmitting a multi-STA block acknowledgement (BA) frame 1155 to STA1 and STA2.

After the DSO operation period expires, STA2 may return back to operating in the P20 channel (where both STA1 and STA2 were originally parked) via switch back operation 1160.

A preliminary procedure for enabling transmission and reception in a DSO subband are now described to provide context.

To perform DSO with a non-AP STA capable of DSO (i.e., a DSO-capable STA), the AP needs to instruct the STA to switch from operating in a non-DSO subband to operating in a designated DSO subband. The AP may initiate the DSO subband switching process by transmitting an initial control frame. Such an initial control frame that initiates DSO may be referred to herein as a DSO initial control frame. In an embodiment, the DSO initial control frame is a BSRP frame. The DSO initial control frame may include the following information on a per-DSO-capable STA basis: 1) a DSO switching command and the location of the DSO subband assigned to the STA; and 2) the resource unit (RU) within the DSO subband in which the STA should transmit its initial control response frame. For example, the AP may indicate in the DSO initial control frame that the STA is assigned to the S80 DSO subband and that the STA should transmit its initial control response frame in a particular 106-tone resource unit (RU) within the S80 DSO subband.

Upon receiving an initial control frame (e.g., which may be a BSRP frame) from the AP, the STA may switch from operating in the non-DSO subband to operating in the DSO subband assigned to the STA in the initial control frame. Subsequently, if the STA is able to transmit an initial control response frame by following the baseline carrier sense (CS) procedure in the DSO subband, it may transmit the initial control response frame (e.g., which may be a BSR frame) in the RU assigned to itself in the initial control frame. The transmission of the initial control response frame may inform the AP that the STA has successfully completed DSO subband switching. The initial control response frame may reuse the existing BSR frame format defined in the IEEE 802.11ax wireless networking standard. Alternatively, the BSR frame format may be modified/extended to explicitly indicate whether the DSO subband switching was successful. In an embodiment, a MPDU containing DSO-related information is aggregated with the BSR frame and transmitted together.

The above-described preliminary procedure may initiate DSO to allow the AP to simultaneously perform transmission and reception with a STA operating in the primary channel/band and a DSO-capable STA operating in a designated DSO subband to improve bandwidth utilization.

As described above, a DSO-capable STA may participate in transmission and reception after performing DSO subband switching to a DSO subband that is outside its current operating bandwidth. Although this can improve bandwidth utilization and data processing efficiency, it may have unintended drawbacks such as increased battery consumption. In particular, if DSO subband switching is performed frequently or if the DSO-capable STA does not participate in actual data transmission and reception after performing DSO subband switching, the disadvantages may outweigh the benefits.

The present disclosure describes solutions to address the problem where a DSO-capable STA, despite successfully performing DSO subband switching at the request of the AP, fails to participate in actual data transmission or reception.

The situations where the AP triggers DSO subband switching can be as follows: 1) when the AP has downlink data to transmit to a DSO-capable STA; 2) When the AP has prior knowledge of the buffered data state of DSO-capable STAs, and initiates DSO to solicit uplink data transmission from a particular DSO-capable STA - that is, to enable the AP to receive uplink data that the DSO-capable STA intends to transmit to the AP; and 3) when the AP does not have downlink data to transmit to a DSO-capable STA and does not have any prior knowledge regarding the DSO-capable STA's buffered data state, but initiates DSO to check whether the DSO-capable STA has uplink data to transmit to the AP.

Each of the above-mentioned situations may occur independently, triggering the AP to initiate DSO, or they may occur in combination (i.e., with "and/or" logic) to justify initiating DSO. For example, if the AP has both downlink data to transmit to a DSO-capable STA and expects to receive uplink data from the DSO-capable STA, the AP may decide to initiate DSO with this DSO-capable STA.

The present disclosure primarily focuses on the third situation mentioned above. Specifically, the present disclosure describes solutions to address the problem that can arise when the AP decides to perform DSO in the third situation. When the AP initiates DSO in the third situation, the following problem may occur. There may be cases where the DSO-capable STA, after having successfully performed DSO subband switching in response to receiving an initial control frame from the AP, does not have any uplink data to transmit. In such cases, since there is no data to transmit or receive between the AP and the DSO-capable STA, there is no benefit gained from performing the DSO subband switching. Instead, the DSO subband switching, which takes the STA outside of its current operating bandwidth, only results in unnecessary battery/energy consumption. This is an inefficient and non-ideal DSO behavior that imposes energy costs on the STA without offering any benefit. As such, there is a need to address this problem. Embodiments address this problem by allowing such a STA to remain operating in the primary (non-DSO) channel/subband (not perform DSO subband switching) to conserve energy.

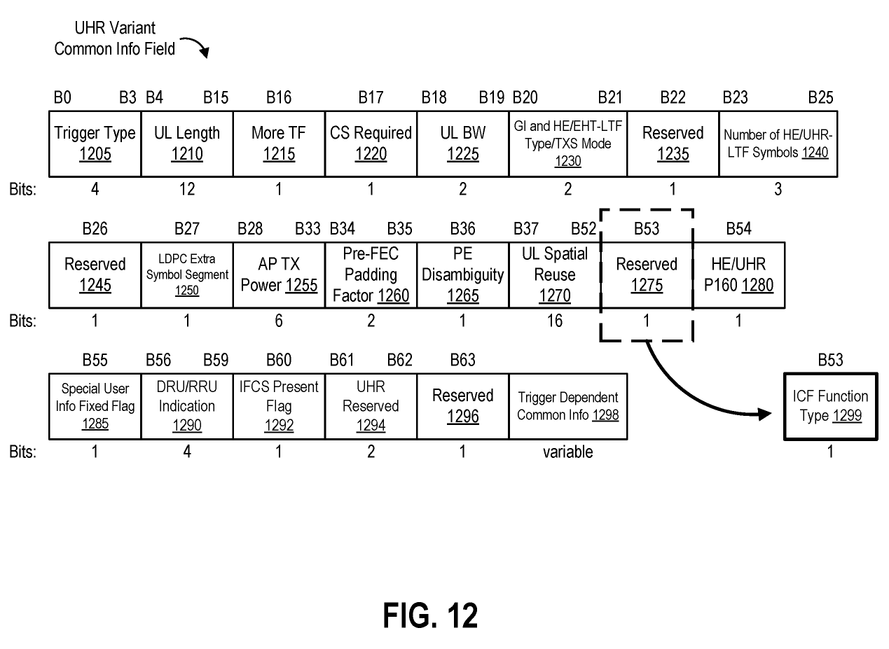

When the AP transmits an initial control frame to initiate DSO, it may include an indication in the initial control frame to indicate that to the DSO-capable STAs that the initial control frame is being transmitted for the purpose of initiating DSO. For example, a reserved bit included in the common information field (also referred to as a common info field) of the initial control frame may be used to indicate that the initial control frame is being transmitted for the purpose of initiating DSO. An example common information field format that includes a reserved field/bit that can be used for indicating that an initial control frame is being transmitted for the purpose of initiating DSO is shown in FIG. 12.

FIG. 12 is a diagram showing a common information field format that includes an ICF function type field that can be used to indicate that an initial control frame is being transmitted for the purpose of initiating DSO, according to some embodiments.

The common information field format shown in the diagram is an example of a UHR variant common information field format. It should be appreciated, however, that embodiments are not limited to being used with this specific common information field format. That is, the specific field format shown in the diagram is provided by way of example, and should not be regarded as limiting embodiments to using a particular field format.

As shown in the diagram, the common information field may include a trigger type field 1205 (4 bits), a UL length field 1210 (12 bits), a more TF field 1215 (1 bit), a CS required field 1220 (1 bit), a UL BW field 1225 (2 bits), a GI and HE/EHT-LTF type / TXS mode field 1230 (2 bits), a reserved field 1235 (1 bit), a number of HE/UHR-LTF symbols field 1240 (3 bits), a reserved field 1245 (1 bit), a LDPC extra symbol segment field 1250 (1 bit), an AP TX power field 1255 (6 bits), a pre-FED padding factor field 1260 (2 bits), a PE disambiguity field 1265 (1 bit), a UL spatial reuse field 1270 (16 bits), a reserved field 1275 (1 bit), a HE/UHR P160 field 1280 (1 bit), a special user info fixed flag field 1285 (1 bit), a DRU/RRU indication field 1290 (4 bits), an IFCS present flag field 1292 (1 bit), a UHR reserved field 1294 (2 bits), a reserved field 1296 (1 bit), and a trigger dependent common info field 1298 (variable length). For sake of brevity, only certain fields that are deemed relevant for understanding embodiments will be described in detail herein. The other fields can be interpreted as functioning in accordance with IEEE 802.11 wireless networking standards.

The common information field may be included in an initial control frame. As shown in the diagram, the reserved field 1275 may be used/redefined as an ICF function type field 1299. The ICF function type field 1299 may be encoded and interpreted as follows. When the ICF function type field 1299 (e.g., bit B53) has a value of binary ‘0’ it may indicate that the purpose of the initial control frame is for initiating non-primary channel access (NPCA) (e.g., (B53:0)→ ICF for NPCA) . When the ICF function type field 1299 has a value of binary ‘1’ it may indicate that the purpose of the initial control frame is for DSO (e.g., (B53:1)→ ICF for DSO)

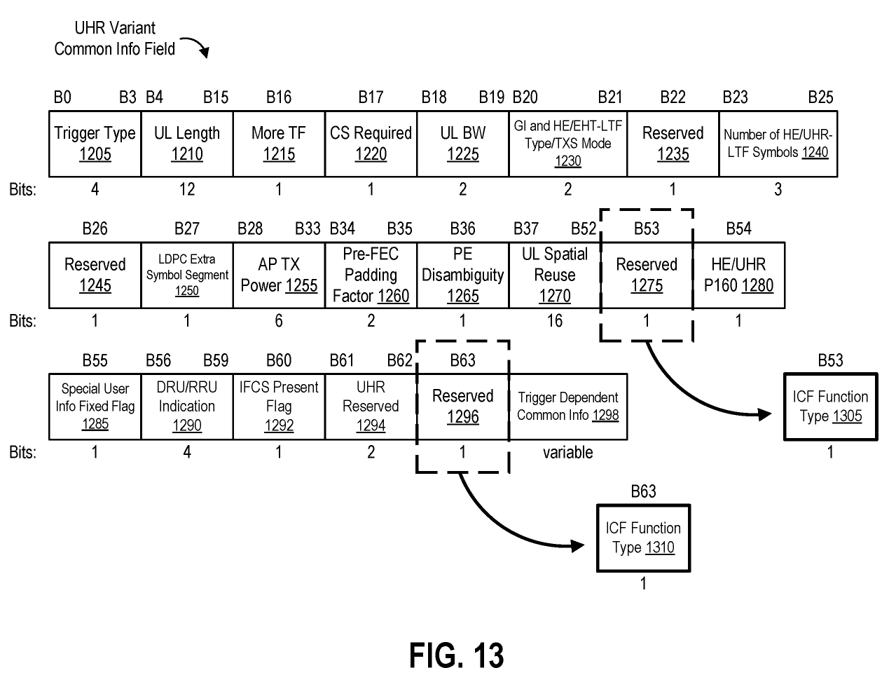

As another example, two bits may be used to indicate the purpose of the initial control frame, as shown in FIG. 13.

FIG. 13 is a diagram showing another common information field format that includes an ICF function type field that can be used to indicate that an initial control frame is being transmitted for the purpose of initiating DSO, according to some embodiments.

The common information field may include the same fields as shown in FIG. 12 and described above in relation thereto. However, the reserved field 1275 and the reserved field 1296 may be used as ICF function type fields. Specifically, the reserved field 1275 may be used as a first ICF function type field 1305 and the reserved field 1296 may be used as a second ICF function type field 1310. These two fields may provide two bits that can be used to encode the purpose of the initial control frame.

When the common information field is included in an initial control frame, these ICF function type fields may be encoded and interpreted as follows. When the first ICF function type field 1305 (e.g., bit B53) has a value of binary ‘0’ and the second ICF function type field 1310 (e.g., bit B63) has a value of binary ‘0’ it may indicate that the purpose of the initial control frame is for initiating non-primary channel access (NPCA) (e.g., (B53: 0, B63: 0) → ICF for NPCA). When the first ICF function type field 1305 has a value of binary ‘0’ and the second ICF function type field 1310 has a value of binary ‘1’ it may indicate that the purpose of the initial control frame is for DSO (e.g., (B53: 0, B63: 1) → ICF for DSO). The other values for the first ICF function type field 1305 and the second ICF function type field 1310 (e.g., binary ‘10’ and binary ‘11’) can be used to indicate other schemes besides NPCA and DSO (e.g., (B53: 1, B63: 0), (B53: 1, B63: 1) → ICF for other schemes).

Through this field format and encoding scheme, DSO-capable STAs can determine what kind of function the initial control frame transmitted by the AP is intended to perform. However, even if the AP informs the STA that the initial control frame is being transmitted for purposes of initiating DSO, this by itself does not solve the problem of unnecessary DSO subband switching mentioned earlier herein.

A solution is described herein to address the problem of unnecessary DSO subband switching. In an embodiment, a new field is added/defined in the initial control frame (that the AP transmits to a STA to initiate DSO) to indicate whether the AP has downlink data to transmit to the target STA. Such field may be referred to herein as a downlink data availability field. The field may have a length of n bits (where n is any positive whole number). For purposes of explanation, it is assumed in the present disclosure that the downlink data availability field has a length of one bit, where a bit value of binary ‘1’ indicates that downlink data is available and a bit value of binary ‘0’ indicates that downlink data is not available. It should be appreciated, however, that the downlink data availability field can have a length that is longer than one bit and/or be encoded differently.

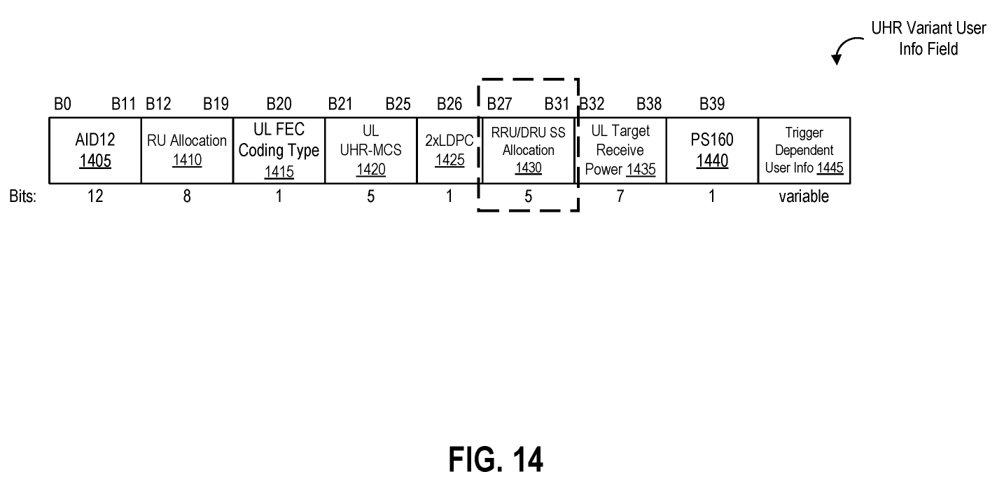

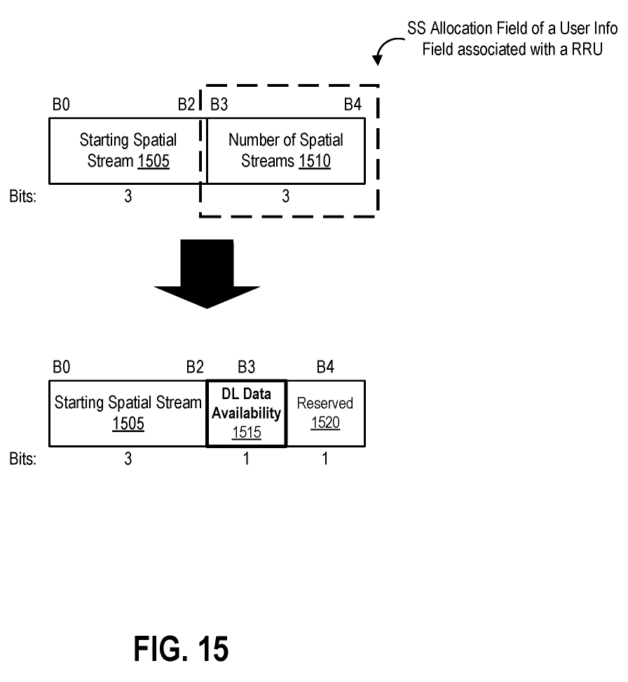

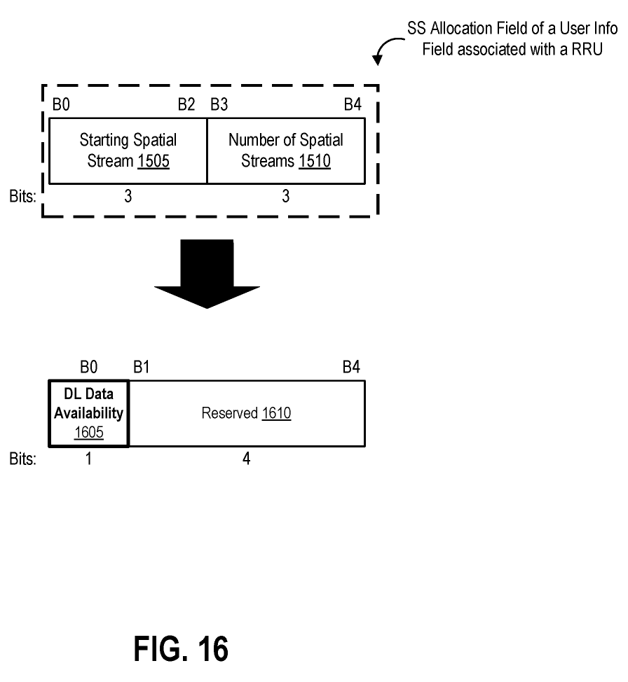

The downlink data availability field may be included in a DSO initial control frame (e.g., BSRP frame) by extending the per-user user information field. The reason for extending the per-user user information field is as follows. To perform DSO, an initial control frame and initial control response frame (ICF/ICR) exchange is performed between the AP and non-AP STAs (which may include both DSO-capable STAs and non-DSO-capable (legacy) STAs). During the ICF/ICR exchange, the AP may include, in the initial control frame, information regarding which STAs should respond with an initial control response frame and information regarding which RU (resource unit) the non-AP STAs should use to transmit the initial control response frame. Since such information is user/STA-specific, it can be included in the user information field of the initial control frame. Since the user information fields can convey user-specific information, it is well-suited for individually indicating whether the AP has downlink data available for each non-AP STA when performing DSO. FIG. 14 shows an example user information field format. FIGS. 15 and 16 show how a field within the user information field can be modified/repurposed to include a downlink data availability field.

FIG. 14 is a diagram showing a user information field format, according to some embodiments. The user information field format shown in the diagram is an example of a UHR variant user information field format. It should be appreciated, however, that embodiments are not limited to being used with this specific user information field format. That is, the specific field format shown in the diagram is provided by way of example, and should not be regarded as limiting embodiments to using a particular field format.

As shown in the diagram, the user information field may include an AID12 field 1405 (12 bits), a RU allocation field 1410 (8 bits), a UL FEC coding type field 1415 (1 bit), a UL UHR-MCS field 1420 (5 bits), a 2xLDPC field 1425 (1 bit), a restricted RU/distributed RU spatial stream allocation field 1430 (5 bits) (which may also be referred to herein simply as a spatial stream allocation field), a UL target receive power field 1435 (7 bits), a PS160 field 1440 (1 bit), and a trigger dependent user info field 1445 (variable length). For sake of brevity, only certain fields that are deemed relevant for understanding embodiments will be described in detail herein. The other fields can be interpreted as functioning in accordance with IEEE 802.11 wireless networking standards.

A DSO initial control frame may include a separate user information field for each DSO-capable STA, as well as for each non-DSO-capable (legacy) STA that will remain operating in the primary channel (in a non-DSO subband) during the initial control frame and initial control response frame (ICF/ICR) exchange procedure for initiating DSO. That is, there can be a separate user information field for each user/STA to carry different (user/STA-specific) information for each user/STA.

For example, to initiate DSO, the AP may need to inform each DSO-capable STA regarding which RU to use when responding with an initial control response frame after performing DSO subband switching. User/STA-specific RU information may be carried in the RU allocation field 1410 of the user information field for each user/STA.

In an embodiment, the user information field is modified to include a downlink data availability field. Existing IEEE 802.11 wireless networking standards have the following constraint: The number of spatial streams in response to the BSRP trigger frame (used as the DSO ICF) shall be limited to one for all the scheduled DSO non-AP STAs and shall be indicated in the BSRP Trigger frame. It is recognized by the present disclosure that based on this constraint, the SS allocation field 1430 (e.g., occupying B27–B31 in the UHR variant user info field format) can be repurposed/reused to indicate downlink data availability status for a STA. Although the SS allocation field 1430 is typically used for indicating regular RU spatial stream allocation, distributed RU spatial stream allocation, and/or distribution bandwidth (DBW) (e.g., used in distributed resource unit (DRU) scenarios), it can be repurposed to indicate downlink data availability status.

FIG. 15 is a diagram showing how a spatial stream allocation field can be repurposed/modified to include a downlink data availability field, according to some embodiments.

As shown in the diagram, the spatial stream allocation field (of a user information field associated with a regular RU) may include a starting spatial stream field 1505 (3 bits) and a number of spatial streams field 1510 (3 bits).

As mentioned earlier herein, the number of spatial streams for a DSO-capable STA transmitting an initial control response frame during the initial control frame and initial control response frame (ICF/ICR) exchange procedure for initiating DSO is always fixed to a value of one (according to the constraint mentioned above). As such, the number of spatial streams field 1510 (occupying bits B3 and B4 of the SS allocation field) is not needed and can be repurposed/modified to include a downlink data availability field 1515. For example, as shown in the diagram, the number of spatial streams field 1510 can be modified/repurposed to include a downlink data availability field 1515 (occupying bit B3 of the SS allocation field) and a reserved field 1520 (occupying bit B4 of the SS allocation field). The downlink data availability field 1515 may indicate the downlink data availability status for the STA. In an embodiment, if the downlink data availability field 1515 has a value of binary ‘0’ it indicates that there is no downlink data for the STA and if the downlink data availability field 1515 has a value of binary ‘1’ it indicates that there is downlink data for the STA (although the opposite convention/encoding is also possible).

When a non-AP STA transmits an initial control response frame for DSO to the AP and MIMO is not used, the starting spatial stream information is not needed and thus the starting spatial stream field 1505 can be modified/repurposed to include a downlink data availability field as shown in FIG. 16.

FIG. 16 is a diagram showing how a spatial stream allocation field can be modified/repurposed to include a downlink data availability field, according to some embodiments.

As shown in the diagram, the SS allocation field can be modified/repurposed to include a downlink data availability field 1605 (occupying bit B0 of the SS allocation field) and a reserved field 1610 (occupying bits B1-B4 of the SS allocation field). The downlink data availability field 1605 may occupy bits that were previously occupied by the starting spatial stream field 1505. The downlink data availability field 1605 may indicate the downlink data availability status for the STA.

Upon receiving an initial control frame from an AP that includes a downlink data availability field, a DSO-capable STA may operate as follows. If the downlink data availability field indicates that the AP has downlink data to transmit to the STA (e.g., the downlink data availability field has a value of binary ‘1’), the STA may switch from operating in the non-DSO subband (e.g., the primary channel) to operating in a designated DSO subband (e.g., designated by the AP) and transmit an initial control response frame as a response to the initial control frame regardless of whether the STA has uplink data to transmit to the AP. However, if the downlink data availability field indicates that the AP does not have any downlink data to transmit to the STA (e.g., the downlink data availability field has a value of binary ‘0’), the STA may decide whether to perform DSO subband switching based on whether it has uplink data to transmit to the AP. For example, if the STA has uplink data to transmit to the AP, it may be efficient for the STA to perform DSO subband switching to the DSO subband indicated in the received initial control frame, so the STA may perform DSO subband switching. However, if the STA does not have any uplink data to transmit to the AP, the STA may decide not to perform DSO subband switching since there is no data to be exchanged with the AP (i.e., there is no downlink data to receive from the AP and no uplink data to transmit to the AP).

Subsequently, the AP may interpret the response or absence of a response frame from a DSO-capable STA as follows. If the AP indicated in the downlink data availability field of the initial control frame (e.g., BSRP frame) that it does not have downlink data to transmit to the STA and yet receives an initial control response frame (e.g., BSR frame) from the STA, the AP may infer that the STA has uplink data to transmit to the AP. This is because if the STA correctly understood that there is no downlink data for itself and it had no uplink data to transmit to the AP, it would not have performed DSO subband switching and would not have transmitted the initial control response frame. Accordingly, if the AP receives an initial control response frame from the STA, the AP may schedule the STA for uplink data transmission during the upcoming DSO operation period.

However, the AP should not assume that the absence of an initial control response frame from a STA means the STA has no uplink data to transmit to the AP for the entire DSO operation period. This is because it is possible that uplink data arrives in the STA’s transmission queue after the initial control frame and initial control response frame (ICF/ICR) exchange has taken place but still within the DSO operation period. For example, if uplink data arrives at a STA immediately after the ICF/ICR exchange has taken place, the AP might not schedule the STA for uplink transmission during the DSO operation period if it did not receive an initial control response frame from the STA. To resolve this issue, non-AP STAs that were indicated as having no downlink data in the initial control frame and did not respond to the initial control frame may still be allowed to transmit uplink data to the AP during the DSO operation period via uplink OFDMA random access (UORA).

The UORA operation may follow the same procedure as defined in the IEEE 802.11ax wireless networking standard. To efficiently utilize the DSO subband, UORA may only be allowed in the primary channel or primary (non-DSO) subband. Also, to increase the likelihood of success in UORA, the OBO counter values of non-AP STAs that received the initial control frame but did not perform DSO subband switching due to not having any downlink data to receive or uplink data to transmit can be lowered. This may help facilitate better RA-RU occupancy during UORA.

Embodiments described herein may provide one or more advantages over existing DSO mechanisms. Embodiments may allow the AP to explicitly indicate downlink data availability status to individual DSO-capable STAs, which can help improve the accuracy of scheduling decisions during the DSO operation period. Embodiments may prevent unnecessary DSO subband switching when no data exchange is expected, which can help reduce battery/energy consumption and interference. Embodiments may provide uplink data transmission opportunities for STAs even for STAs that did not respond to the DSO initial control frame, which can help reduce latency and enhance reliability and throughput. Embodiments may improve overall network efficiency by better coordinating uplink/downlink resource allocation and DSO subband utilization. Embodiments may provide a flexible and extensible framework for DSO operation signaling that uses/repurposes existing user information fields, which can help facilitate backward compatibility and seamless integration with existing implementations/deployments.

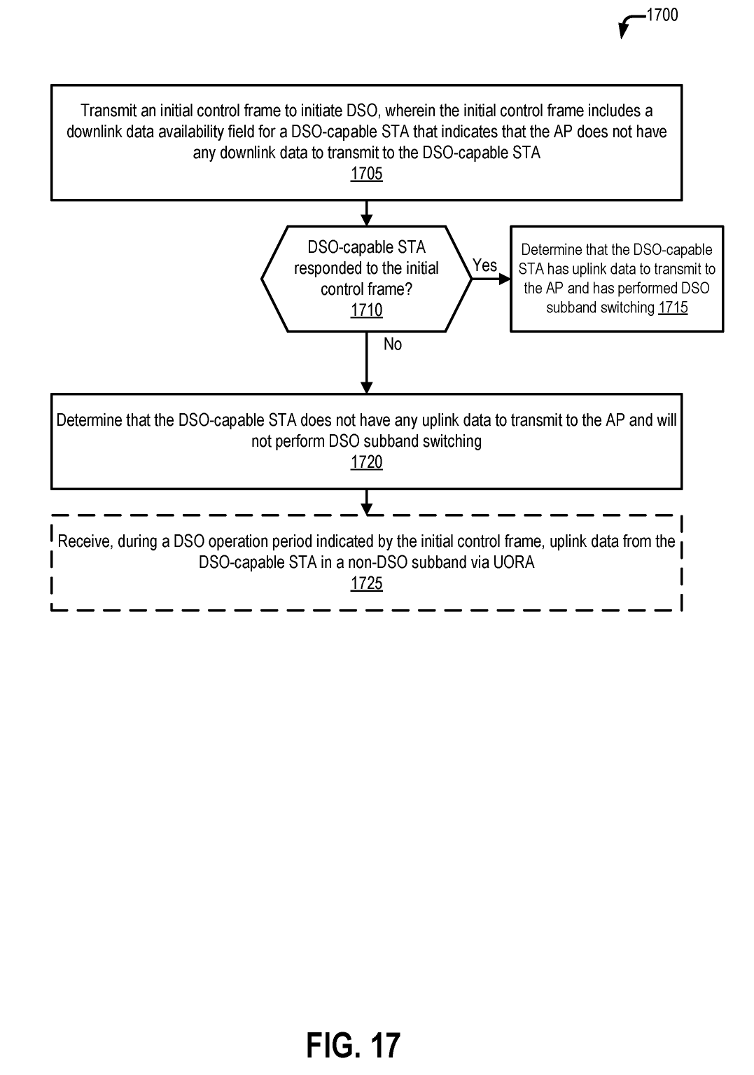

Turning now to FIG. 17, a method 1700 will be described for initiating DSO, in accordance with an example embodiment. The method 1700 may be performed by an AP. The AP may be implemented by a wireless device (e.g., wireless device 104).

Additionally, although shown in a particular order, in some embodiments the operations of the method 1700 (and the other methods shown in the other figures) may be performed in a different order. For example, although the operations of the method 1700 are shown in a sequential order, some of the operations may be performed in partially or entirely overlapping time periods.

At operation 1705, the AP transmits an initial control frame to initiate DSO, wherein the initial control frame includes a downlink data availability field for a DSO-capable STA that indicates that the AP does not have any downlink data to transmit to the DSO-capable STA. In an embodiment, the initial control frame includes a user information field for the DSO-capable STA that includes the downlink data availability field for the DSO-capable STA. In an embodiment, the user information field for the DSO-capable STA includes a spatial stream allocation field that is repurposed to include the downlink data availability field for the DSO-capable STA. As used herein, a field being repurposed means that the field is ordinarily used for one purpose but is now being used for a different purpose (e.g., the spatial stream allocation field is ordinary used for indicating starting spatial stream information and number of spatial streams information but can be repurposed to indicate downlink data availability status). In an embodiment, the spatial stream allocation field includes a number of spatial streams field that is repurposed to include the downlink data availability field for the DSO-capable STA (e.g., as shown in FIG. 15). In an embodiment, the spatial stream allocation field includes a starting spatial stream field that is repurposed to include the downlink data availability field for the DSO-capable STA (e.g., as shown in FIG. 16). In an embodiment, the spatial stream allocation field occupies bits B27 to B31 of the user information field for the DSO-capable STA (e.g., in a UHR variant user information field as shown in FIG. 14). In an embodiment, the downlink data availability field for the DSO-capable STA has a length of one bit.

In an embodiment, the initial control frame includes an initial control frame function type field that indicates that the initial control frame is being transmitted to initiate DSO. In an embodiment, the initial control frame includes a common information field that includes the initial control frame function type field (e.g., as shown in FIGS. 12 or 13). In an embodiment, the initial control frame function type field occupies bits B53 and/or B56 of the common information field (e.g., as shown in FIGS. 12 or 13).

At operation 1710, the AP determines whether the DSO-capable STA responded to the initial control frame. If the DSO-capable STA responded to the initial control frame, the method may proceed to operation 1715, at which the AP determines that the DSO-capable STA has uplink data to transmit to the AP and has performed DSO subband switching. Thus, the AP may schedule the STA for uplink transmission during the upcoming DSO operation period. Otherwise, if the DSO-capable STA did not respond to the initial control frame, the method may proceed to operation 1720.

At operation 1720, the AP determines that the DSO-capable STA does not have any uplink data to transmit to the AP and will not perform DSO subband switching. Thus, the AP may decide not to schedule the STA for reception/transmission during the upcoming DSO operation period.

In an embodiment, at operation 1725, the AP receives, during a DSO operation period indicated by the initial control frame, uplink data from the DSO-capable STA in a non-DSO subband via UORA.

In an embodiment, the initial control frame further includes a second downlink data availability field for a second DSO-capable STA that indicates that the AP does not have any downlink data to transmit to the second DSO-capable STA. In such an embodiment, the AP may receive an initial control response frame from the second DSO-capable STA as a response to the initial control frame, determine that the second DSO-capable STA has uplink data to transmit to the AP and has performed DSO subband switching in response to receiving the initial control response frame from the second DSO-capable STA, and receive, during a DSO operation period indicated by the initial control frame, uplink data from the second DSO-capable STA in a DSO subband.

In an embodiment, the initial control frame further includes a second downlink data availability field for a second DSO-capable STA that indicates that the AP has downlink data to transmit to the second DSO-capable STA. In such an embodiment, the AP may receive an initial control response frame from the second DSO-capable STA as a response to the initial control frame, determine that the second DSO-capable STA has performed DSO subband switching in response to receiving the initial control response frame from the second DSO-capable STA, and transmit, during a DSO operation period indicated by the initial control frame, downlink data to the second DSO-capable STA in a DSO subband.

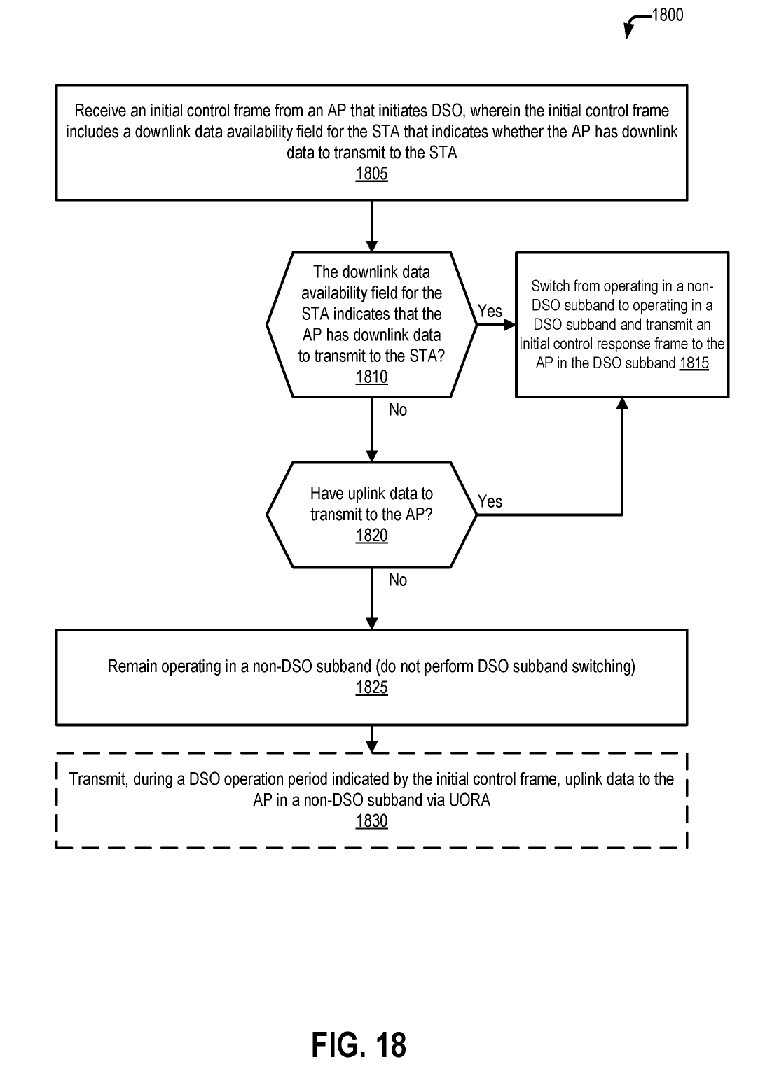

Turning now to FIG. 18, a method 1800 will be described for determining whether to perform DSO subband switching, in accordance with an example embodiment. The method 1800 may be performed by a DSO-capable (non-AP) STA. The STA may be implemented by a wireless device (e.g., wireless device 104).

At operation 1805, the STA receives an initial control frame from an AP that initiates DSO, wherein the initial control frame includes a downlink data availability field for the STA that indicates whether the AP has downlink data to transmit to the STA. In an embodiment, the initial control frame includes a user information field for the STA that includes the downlink data availability field for the STA. In an embodiment, the user information field for the STA includes a spatial stream allocation field that is repurposed to include the downlink data availability field for the STA. In an embodiment, the spatial stream allocation field includes a number of spatial streams field that is repurposed to include the downlink data availability field for the STA (e.g., as shown in FIG. 15). In an embodiment, the spatial stream allocation field includes a starting spatial stream field that is repurposed to include the downlink data availability field for the STA (e.g., as shown in FIG. 16). In an embodiment, the spatial stream allocation field occupies bits B27 to B31 of the user information field for the STA (e.g., in a UHR variant user information field as shown in FIG. 14). In an embodiment, the downlink data availability field for the STA has a length of one bit.

In an embodiment, the initial control frame includes an initial control frame function type field that indicates that the initial control frame is being transmitted to initiate DSO. In an embodiment, the initial control frame includes a common information field that includes the initial control frame function type field (e.g., as shown in FIGS. 12 or 13). In an embodiment, the initial control frame function type field occupies bits B53 and/or B56 of the common information field (e.g., as shown in FIGS. 12 or 13).

At operation 1810, the STA determines whether the downlink data availability field for the STA indicates that the AP has downlink data to transmit to the STA. If the downlink data availability field for the STA indicates that the AP has downlink data to transmit to the STA, the method may proceed to operation 1815, at which the STA switches from operating in a non-DSO subband to operating in a DSO subband and transmits an initial control response frame to the AP in the DSO subband. Otherwise, if the downlink data availability field for the STA indicates that the AP does not have any downlink data to transmit to the STA, the method may proceed to operation 1820.

At operation 1820, the STA determines whether it has uplink data to transmit to the AP. If the STA has uplink data to transmit to the AP, the method may proceed to operation 1815, at which the STA switches from operating in a non-DSO subband to operating in a DSO subband and transmits an initial control response frame to the AP in the DSO subband. Otherwise, if the STA does not have uplink data to transmit to the AP, the method may proceed to operation 1825.

At operation 1825, the STA remains operating in a non-DSO subband (does not perform DSO subband switching). In an embodiment (when the STA remains operating in the non-DSO subband), at operation 1830, the STA transmits, during a DSO operation period indicated by the initial control frame, uplink data to the AP in a non-DSO subband via UORA. In an embodiment, an OBO counter for the STA is lowered to improve random access resource unit (RA-RU) occupancy during the UORA.

In an embodiment, the STA receives a second initial control frame from the AP that initiates DSO, wherein the second initial control frame includes a second downlink data availability field for the STA that indicates that the AP does not have any downlink data to transmit to the STA, switches from operating in the non-DSO subband to operating in a DSO subband in response to determining that the STA has uplink data to transmit to the AP, transmits an initial control response frame to the AP in the DSO subband as a response to the second initial control frame, and transmits, during a DSO operation period indicated by the second initial control frame, uplink data to the AP in the DSO subband.

In an embodiment, the STA receives a second initial control frame from the AP that initiates DSO, wherein the second initial control frame includes a second downlink data availability field for the STA that indicates that the AP has downlink data to transmit to the STA, switches from operating in the non-DSO subband to operating in a DSO subband in response to determining, based on the second downlink data availability field for the STA, that the AP has downlink data to transmit to the STA, transmits an initial control response frame to the AP in the DSO subband as a response to the second initial control frame, and receives, during a DSO operation period indicated by the second initial control frame, downlink data from the AP in the DSO subband.

Although many of the solutions and techniques provided herein have been described with reference to a WLAN system, it should be understood that these solutions and techniques are also applicable to other network environments, such as cellular telecommunication networks, wired networks, etc. In some embodiments, the solutions and techniques provided herein may be or may be embodied in an article of manufacture in which a non-transitory machine-readable medium (such as microelectronic memory) has stored thereon instructions which program one or more data processing components (generically referred to here as a “processor” or “processing unit”) to perform the operations described herein. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In some cases, an embodiment may be an apparatus (e.g., an AP STA, a non-AP STA, or another network or computing device) that includes one or more hardware and software logic structures for performing one or more of the operations described herein. For example, as described herein, an apparatus may include a memory unit, which stores instructions that may be executed by a hardware processor installed in the apparatus. The apparatus may also include one or more other hardware or software elements, including a network interface, a display device, etc.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system may carry out the computer-implemented methods described herein in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method performed by an access point (AP) to initiate dynamic subband operation (DSO), the method comprising:
transmitting an initial control frame to initiate DSO, wherein the initial control frame includes a downlink data availability field for a DSO-capable station (STA) that indicates that the AP does not have any downlink data to transmit to the DSO-capable STA; and
determining that the DSO-capable STA does not have any uplink data to transmit to the AP and will not perform DSO subband switching in response to determining that the DSO-capable STA did not respond to the initial control frame.

2. The method of claim 1, wherein the initial control frame includes a user information field for the DSO-capable STA that includes the downlink data availability field for the DSO-capable STA.

3. The method of claim 2, wherein the user information field for the DSO-capable STA includes a spatial stream allocation field that is repurposed to include the downlink data availability field for the DSO-capable STA.

4. The method of claim 3, wherein the spatial stream allocation field includes a number of spatial streams field that is repurposed to include the downlink data availability field for the DSO-capable STA.

5. The method of claim 3, wherein the spatial stream allocation field includes a starting spatial stream field that is repurposed to include the downlink data availability field for the DSO-capable STA.

6. The method of claim 3, wherein the spatial stream allocation field occupies bits B27 to B31 of the user information field for the DSO-capable STA.

7. The method of claim 1, wherein the downlink data availability field for the DSO-capable STA has a length of one bit.

8. The method of claim 1, further comprising:
receiving, during a DSO operation period indicated by the initial control frame, uplink data from the DSO-capable STA in a non-DSO subband via uplink orthogonal frequency division multiple access random access (UORA).

9. The method of claim 1, wherein the initial control frame further includes a second downlink data availability field for a second DSO-capable STA that indicates that the AP does not have any downlink data to transmit to the second DSO-capable STA.

10. The method of claim 9, further comprising:
receiving an initial control response frame from the second DSO-capable STA as a response to the initial control frame;
determining that the second DSO-capable STA has uplink data to transmit to the AP and has performed DSO subband switching in response to receiving the initial control response frame from the second DSO-capable STA; and
receiving, during a DSO operation period indicated by the initial control frame, uplink data from the second DSO-capable STA in a DSO subband.

11. The method of claim 1, wherein the initial control frame further includes a second downlink data availability field for a second DSO-capable STA that indicates that the AP has downlink data to transmit to the second DSO-capable STA.

12. The method of claim 11, further comprising:
receiving an initial control response frame from the second DSO-capable STA as a response to the initial control frame;
determining that the second DSO-capable STA has performed DSO subband switching in response to receiving the initial control response frame from the second DSO-capable STA; and
transmitting, during a DSO operation period indicated by the initial control frame, downlink data to the second DSO-capable STA in a DSO subband.

13. The method of claim 1, wherein the initial control frame includes an initial control frame function type field that indicates that the initial control frame is being transmitted to initiate DSO.

14. The method of claim 13, wherein the initial control frame includes a common information field that includes the initial control frame function type field.

15. The method of claim 14, wherein the initial control frame function type field occupies bits B53 and/or B56 of the common information field.

16. A method performed by a station (STA) to determine whether to perform dynamic subband operation (DSO) subband switching, the method comprising:
receiving an initial control frame from an access point (AP) that initiates DSO, wherein the initial control frame includes a downlink data availability field for the STA that indicates that the AP does not have any downlink data to transmit to the STA; and
remain operating in a non-DSO subband in response to determining that the STA does not have any uplink data to transmit to the AP and determining, based on the downlink data availability field for the STA, that the AP does not have any downlink data to transmit to the STA.

17. The method of claim 16, wherein the initial control frame includes a user information field for the STA that includes the downlink data availability field for the STA.

18. The method of claim 17, wherein the user information field for the STA includes a spatial stream allocation field that is repurposed to include the downlink data availability field for the STA.

19. The method of claim 18, wherein the spatial stream allocation field includes a number of spatial streams field that is repurposed to include the downlink data availability field for the STA.

20. The method of claim 18, wherein the spatial stream allocation field includes a starting spatial stream field that is repurposed to include the downlink data availability field for the STA.

21. The method of claim 18, wherein the spatial stream allocation field occupies bits B27 to B31 of the user information field for the STA.

22. The method of claim 16, wherein the downlink data availability field for the STA has a length of one bit.

23. The method of claim 16, further comprising:
transmitting, during a DSO operation period indicated by the initial control frame, uplink data to the AP in a non-DSO subband via uplink orthogonal frequency division multiple access random access (UORA).

24. The method of claim 23, wherein an orthogonal frequency division multiple access backoff (OBO) counter for the STA is lowered to improve random access resource unit occupancy during the UORA.

25. The method of claim 16, further comprising:
receiving a second initial control frame from the AP that initiates DSO, wherein the second initial control frame includes a second downlink data availability field for the STA that indicates that the AP does not have any downlink data to transmit to the STA;
switching from operating in the non-DSO subband to operating in a DSO subband in response to determining that the STA has uplink data to transmit to the AP;
transmitting an initial control response frame to the AP in the DSO subband as a response to the second initial control frame; and
transmitting, during a DSO operation period indicated by the second initial control frame, uplink data to the AP in the DSO subband.

26. The method of claim 16, further comprising:
receiving a second initial control frame from the AP that initiates DSO, wherein the second initial control frame includes a second downlink data availability field for the STA that indicates that the AP has downlink data to transmit to the STA;
switching from operating in the non-DSO subband to operating in a DSO subband in response to determining, based on the second downlink data availability field for the STA, that the AP has downlink data to transmit to the STA;
transmitting an initial control response frame to the AP in the DSO subband as a response to the second initial control frame; and
receiving, during a DSO operation period indicated by the second initial control frame, downlink data from the AP in the DSO subband.

27. The method of claim 16, wherein the initial control frame includes an initial control frame function type field that indicates that the initial control frame is being transmitted to initiate DSO.

28. The method of claim 27, wherein the initial control frame includes a common information field that includes the initial control frame function type field.

29. The method of claim 28, wherein the initial control frame function type field occupies bits B53 and/or B56 of the common information field.

30. A wireless device configured to implement an access point (AP) in a wireless network, the wireless device comprising:
a radio frequency transceiver;
a memory device storing a set of instructions; and
a processor coupled to the memory device, wherein the set of instructions, when executed by the processor, causes the AP to:
transmit an initial control frame to initiate dynamic subband operation (DSO), wherein the initial control frame includes a downlink data availability field for a DSO-capable station (STA) that indicates that the AP does not have any downlink data to transmit to the DSO-capable STA; and
determining that the DSO-capable STA does not have any uplink data to transmit to the AP and will not perform DSO subband switching in response to determining that the DSO-capable STA did not respond to the initial control frame.

31. A wireless device configured to implement a station (STA) in a wireless network, the wireless device comprising:
a radio frequency transceiver;
a memory device storing a set of instructions; and
a processor coupled to the memory device, wherein the set of instructions, when executed by the processor, causes the STA to:
receive an initial control frame from an access point (AP) that initiates dynamic subband operation (DSO), wherein the initial control frame includes a downlink data availability field for the STA that indicates that the AP does not have any downlink data to transmit to the STA; and
remain operating in a non-DSO subband in response to determining that the STA does not have any uplink data to transmit to the AP and determining, based on the downlink data availability field for the STA, that the AP does not have any downlink data to transmit to the STA.
